(19) United States
(12) Patent Application Publication
(10) Pub. No.: US 2025/0183720 A1
(43) Pub. Date: Jun. 5, 2025

(54) WEARABLE WIRELESS POWER RECEIVER AND CEILING-MOUNTABLE POWER TRANSMITTER

(71) Applicant: Huawei Digital Power Technologies Co., Ltd., Shenzhen (CN)

(72) Inventors: Fralett SUAREZ SANDOVAL, Munich (DE); Sarai Malinal TORRES DELGADO, Munich (DE)

(73) Assignee: Huawei Digital Power Technologies Co., Ltd., Shenzhen (CN)

(21) Appl. No.: 18/978,795

(22) Filed: Dec. 12, 2024

Related U.S. Application Data
(63) Continuation of application No. PCT/EP2022/066015, filed on Jun. 13, 2022.

(51) Int. Cl. H02J 50/12; H02J 50/40; H02J 50/70

(52) U.S. Cl. CPC H02J 50/12; H02J 50/40; H02J 50/70

(57) ABSTRACT

A wearable wireless power receiver arrangement comprising such wearable wireless power receiver, a wearable coupled resonator array comprising such wearable wireless power receiver, a ceiling-mountable power transmitter and a method for powering a wearable electronic device are provided which, in particular relate to wireless power delivery in dynamic environments. A wearable wireless power receiver that may be configured for location at the head of a person; comprises: a carrier substrate; an electrically conductive material mounted at the carrier substrate, the electrically conductive material forming at least one receiver coil, wherein the carrier substrate with the mounted electrically conductive material is formed to adapt to a head area of the person, wherein the at least one receiver coil is configured to receive an electromagnetic field.

### CROSS-REFERENCE TO RELATED APPLICATIONS

This application is a continuation of International Application No. PCT/EP2022/066015, filed on Jun. 13, 2022, the disclosure of which is hereby incorporated by reference in its entirety.

### TECHNICAL FIELD

Embodiments of the disclosure relate to the field of wireless power transfer. In particular, embodiments of the disclosure relate to a wearable wireless power receiver, a wearable wireless power receiver arrangement comprising such wearable wireless power receiver, a wearable coupled resonator array comprising such wearable wireless power receiver, a ceiling-mountable power transmitter and a method for powering a wearable electronic device, in particular, relate to wireless power delivery in dynamic environments.

### BACKGROUND

In currently available wireless power transfer systems to charge battery-powered devices, the mayor engineering challenge is the reduced positioning freedom of the target device(s). Making this type of technology highly sensitive to lateral or angular misalignments between the transmitter and receiver devices. This causes the problem that the receiver device is not properly charged or even not charged at all in some locations, and in the worst case, the receiver device can actually be damaged when placed in a zone that presents him with a high coupling factor to the transmitter. Another problem of the reduction of the wireless power transfer efficiency due to coupling variations is that most systems require the user to stop using the device when placing it on a charging surface that in some cases has little positioning freedom and in others has some freedom usually on a two-dimensional plane of motion for the receiver.

Some electronic devices have been designed to be worn by the user, for example a device that allows the user to communicate wirelessly to another user while being in a production plant or while working in a grocery store, another example are the head-mounted devices like extended-reality headsets. Supplying to worn devices presents a challenge because they have to be worn for an extended period of time and their batteries have a limited power delivery capability. Increasing the size of the battery or introducing external battery banks supplying to the device comes at the expense of having the user wearing a device that is heavy and uncomfortable. Electrically connecting the device to a power supply, reduces the mobility of the user.

### SUMMARY

Embodiments of this disclosure provide a solution for wireless power delivery to wearable electronic devices that is comfortable for the user.

Further, embodiments of this disclosure provide a way of continuously supplying the battery of electronic devices meant to be worn by the user, e.g., around the head area or carried by the user or that are in close contact to him while allowing him to freely move on a designated space while using the device. This problem is solved by employing wireless power transfer systems subjected to a very large-coupling factor variation. Additionally, this disclosure also reveals an alternative wireless power delivery method to an intermediate device of some of the embodiments and application scenarios of this disclosure. Therefore, the solution presented hereinafter can provide power to multiple receiver devices.

Embodiments of this disclosure provide an alternative to a stationary power supply which allows the devices to be used continuously, potentially allowing to reduce the battery size and consequently reducing the overall size and weight of the device to be charged, resulting in a more portable, compact and comfortable fit.

Embodiments of this disclosure also provide a wireless power transfer system working under the magnetic resonant wireless power transfer principle. The system can be used to supply continuous power to electronic devices that, while in use, require the user to be subjected to a certain mobility range. The system may include the following components: a transmitter device, a power distribution method, at least one receiver device and the electronic device requiring power.

The disclosed transmitter device may be placed above the user wearing an enabled wireless power receiver on the head area. The transmitter device is embodied as a hanging or suspended structure containing the power conversion modules. In order to use the power coming from the transmitter, the wireless power enabled-receiver can receive the power coming from the transmitter, convert it from an AC to a DC signal, then the power can be distributed to the device requiring charge. In some other implementations, the distribution can happen before the power conversion step.

The use of such a transmitter-receiver system allows to provide a continuous power supply to receiver devices subjected to a high-dynamic range while being worn by the user, in particular to head-mounted devices like extended reality headsets, thus avoiding having to carry a heavy battery bank to continuously supply the device being used.

The disclosure presents the system architecture, application scenarios, various types of possible implementations of the transmitter, receiver, and power distribution modules, as well as operating methods.

In order to describe the disclosure in detail, the following terms and notations will be used.
WPT wireless power transfer
PCB printed circuit board
X-reality extended reality
DC direct current
AC alternating current
AC-DC alternating current to direct current converter
DC-DC direct current to direct current converter

In this disclosure, wireless power transfer (WPT) systems are described, in particular one-to-one WPT systems, one-to-many WPT systems, many-to-one WPT systems and many-to-many WPT systems.

One-to-one WPT systems are wireless power transfer systems composed by a single transmitter and a single receiver device. One-to-many WPT systems are wireless power transfer systems composed by a single transmitter and multiple receiver devices. Many-to-one WPT systems are wireless power transfer systems composed by multiple transmitter and a single receiver device. Many-to-many WPT systems are wireless power transfer systems composed by multiple transmitter and multiple receiver devices.

In this disclosure, wearable devices, i.e., devices wearable by a user, are described. Such devices include for example, devices like smartphones, wearables like smartwatches, fitness bands, head-mounted devices like virtual, augmented or mixed reality headsets, and hand-controllers, over-ear headphones, tablets, portable computers, smart glasses, gaming controllers, communication devices like radios, desktop accessories like a mouse or keyboard, battery banks, remote controls, hand-held terminals, e-mobility devices, portable gaming consoles, portable music players, key fobs, drones used in wireless power transfer systems that allow a high-degree of freedom of the receiver.

In the context of charging a wearable device, different technologies, such as wireless power transfer or wireless charging, contact charging, power sharing and external power supply can be applied. Wireless power transfer is the transmission of electrical energy without the use of wires as a physical link. This technology uses a transmitter device capable of generating a time-varying electromagnetic field that causes a circulating electric field through a receiver device (or devices) based on the principle of electromagnetic induction. The receiver device (or devices) is (are) capable of being supplied directly from this circulating electric field or they convert it to a suitable power level to supply to an electrical load or battery connected to them.

Contact charging, also known as surface charging is another type of cord-free power delivery that uses electrical connection of conductive surfaces between the device providing the power and the device receiving the power.

In power sharing, a battery-powered electronic device can be maintained charged by using an external battery bank or external power supplies being electrically connected to it. This can be implemented by, for example, a battery bank worn concurrently by the user and making an electrical connection to the device that needs to be charged. A similar approach is used to share the available power of another portable device like a smartphone by making an electrical connection between the smartphone and the device.

Ultimately, an electronic device can be continuously charged by electrically connecting to an external DC power supply. In such a situation, the battery inside the device can even be removed and thereby having a continuous supply without requiring a battery.

In the following, wireless power transmission systems are described.

Nowadays the number of battery-powered electronic devices is increasing rapidly because they provide freedom of movement and portability. These devices should be continuously recharged to ensure they function. Their charging frequency can be diminished by the use of a large battery, but these impact the overall cost of the electronic device, as well as their weight and size.

Charging of battery-powered electronic devices is usually done with the use of a wall charger and a dedicated cable that connects to an input port of the device to be charged to establish an electrical connection between the power supply and the power-hungry device. Some disadvantages of this charging mechanism are summarized as: a) the connector at this input port is susceptible to mechanical failure due to the connection/disconnection cycles required to charge the battery; b) each battery-powered device comes with its dedicated cable and wall charger. These two components function sometimes exclusively with each device and are not interchangeable between devices. This increases the cost of the device and the electronic-waste generated by the non-functional wall chargers and cables; c) the production of waterproof devices becomes more challenging due to the higher cost associated with the enclosure required around the input port of the battery-powered electronic device; and d) the use of a cable restricts the mobility of the user according to the length of the charging cable.

In order to avoid these disadvantages, several methods for wireless power transmission (WPT) to recharge the battery of the electronic device without the use of a charging cable have been proposed recently.

Commercial wireless power transfer systems have mainly been driven by two organizations, the Wireless Power Consortium and the AirFuel Alliance. The Wireless Power Consortium created the Qi Standard to wirelessly charge consumer electronic devices using magnetic induction from a base station, usually a thin mat-like device, containing one or more transmitter inductors and a target device fitted with a receiving inductor. Qi systems require close proximity of the transmitter and receiver devices, usually within a couple of millimeters to a couple of centimeters.

Wireless power transfer systems that function under the AirFuel Alliance principle use a resonant inductive coupling between the transmitter inductor and the receiver inductor to consequently charge the battery connected to the receiver device. The resonant coupling allows for the power to be transferred over greater distances. The overall system efficiency is a function of the resonators' quality factor and the coupling factor between their inductive elements.

According to a first aspect, embodiments of the disclosure relate to a wearable wireless power receiver for receiving an electromagnetic field and transforming the electromagnetic field into electric power for powering a wearable electronic device, the wearable wireless power receiver being configured for location at the head of a person, the wearable wireless power receiver comprising: a carrier substrate; an electrically conductive material mounted at the carrier substrate, the electrically conductive material forming at least one receiver coil, wherein the carrier substrate with the mounted electrically conductive material is formed to adapt to a head area of the person, wherein the at least one receiver coil is configured to receive an electromagnetic field.

Such a wearable wireless power receiver provides the advantage of supplying power to the wearable electronic device by converting the received wireless power from a transmitter device while the user is comfortably wearing the electronic device. The wearable wireless power receiver allows for a continuous powering of electronic devices that are intended to be worn by the user, e.g., around the head area or carried by the user or that are in close contact to him while allowing him to freely move on a designated space while using the device. The wearable wireless power receiver provides an alternative to a stationary power supply which allows the devices to be used continuously, potentially allowing to reduce the battery size and consequently to reduce the overall size and weight of the device to be charged, resulting in a more portable, compact and comfortable fit.

In this context, the term “configured for location at the head” means that the wearable wireless power receiver can be attached, fixed or embedded below, around, inside or within audio and or visual headsets or even headwear at the head of the person for example in a hat, a beanie or a helmet.

In an implementation of the wearable wireless power receiver, the wearable wireless power receiver comprises a shielding material mounted at the carrier substrate, the shielding material being configured to shield the head of the person from at least a portion of the electromagnetic field.

Such a wearable wireless power receiver provides the advantage of an effective shielding of the head of the person wearing the receiver from the electromagnetic field.

The carrier substrate may comprise a first surface configured to face the head of the person and a second surface opposing the first surface. The shielding material may be mounted at the first surface of the carrier substrate, and the electrically conductive material forming the at least one receiver coil may be mounted at the second surface of the carrier substrate.

In an implementation of the wearable wireless power receiver, the carrier substrate with the mounted electrically conductive material and with or without the shielding material is formed to be removably attached at an upper part of a headwear or a headset device to be worn by the person.

This provides the advantage that the receiver can be flexible attached and detached from the headwear and can be used if required. The receiver can also be attached to different kinds of headwear of the user.

In an implementation of the wearable wireless power receiver, the carrier substrate with the mounted electrically conductive material and with or without the shielding material is formed to be embedded into a headwear to be worn by the person.

This provides the advantage the receiver can be comfortably worn by the person.

In an implementation of the wearable wireless power receiver, the carrier substrate with the mounted electrically conductive material and with or without the shielding material is formed to be embedded into the wearable electronic device.

This provides the advantage that the user can use an existing electronic device as the wearable power receiver.

The wearable wireless power receiver may comprise: a power conversion entity configured to transform the electromagnetic field received by the wireless power receiver into electric power and to provide the electric power via an electric guide to the wearable electronic device.

The wearable wireless power receiver may comprise: an electrical connector for connecting an electrical cable as the electric guide. The electrical connector may be configured to provide the electric power via the electrical cable to the wearable electronic device.

According to a second aspect, embodiments of the disclosure relate to a wearable coupled resonator array comprising, a wearable wireless power receiver according to the first aspect; wherein the wearable coupled resonator array is configured to extend from the head area of the person to a location of the wearable electronic device or to a location of a second wearable electronic device, wherein the wearable coupled resonator array is configured to receive an electromagnetic field and to relay it from the head area of the person to the location of the wearable electronic device or to the location of the second wearable electronic device.

Such a wearable coupled resonator array allows for an easy mount, to be worn close to the user's body allowing him to freely move without constraints. It allows the power to be distributed all the way from the head area of the user to the device requiring charge. In some implementations directly to a head-mounted device, like extended reality headsets. In some other implementations requiring an external processing unit such as a smartphone, the distribution can happen before the power conversion step and travel in a first step from the head area of the user to the user's pocket or wherever such unit is carried and in a second step from the processing unit to the head-mounted device.

The wearable electronic device and/or the second wearable electronic device may comprise a wireless power receiver entity of its own that is configured to receive the electromagnetic field from the coupled resonator array.

According to a third aspect, embodiments of the disclosure relate to a wearable wireless power receiver arrangement for powering at least one of a wearable electronic device or a second wearable electronic device, the wearable wireless power receiver arrangement comprising: a wearable wireless power receiver according to the first aspect, or a wearable coupled resonator array according to the second aspect; a wearable electronic device and/or a second wearable electronic device configured to be powered by the wearable wireless power receiver; and an electric guide configured to transport the electric power from at least one of the wearable wireless power receiver and the second wearable electronic device to at least one of the wearable electronic device and the second wearable electronic device.

Such a wearable wireless power receiver arrangement provides the advantage of an efficient power delivery of the received wireless power to wearable electronic devices that is comfortable for the user. The wearable wireless power receiver arrangement allows for a continuous powering of electronic devices that can be worn by the user while allowing him to freely move on a designated space while using the device. The wearable wireless power receiver arrangement provides an alternative to a stationary power supply which allows the devices to be used continuously, potentially allowing to reduce the battery size and consequently to reduce the overall size and weight of the device to be charged, resulting in a more portable, compact and comfortable fit.

In an implementation of the wearable wireless power receiver arrangement, the second wearable electronic device is configured to charge itself with part of the electric power and forward the rest of the electric power received via a first electric guide from the wearable wireless power receiver via a second electric guide to the wearable electronic device.

This provides the advantage of flexible charging multiple electronic devices. The electric power from the receiver can be advantageously relayed between the multiple electronic devices.

In an implementation of the wearable wireless power receiver arrangement, the second wearable electronic device comprises a wireless power receiver entity that is configured to: receive the electromagnetic field from a coupled resonator array, convert the electromagnetic field into electric power, charge itself with part of the electric power, and/or forward the remaining part of the electric power via an electric guide to the wearable electronic device.

This provides the advantage of flexible charging multiple electronic devices. The electric power can be flexible received from the wireless power receiver or from a coupled resonator array.

According to a fourth aspect, embodiments of the disclosure relate to a ceiling-mountable power transmitter for powering at least one of a wearable electronic device and a second wearable electronic device through the use of a wearable wireless power receiver arrangement according the third aspect, the ceiling-mountable power transmitter comprising: a power source; a carrier substrate; an electrically conductive material mounted at the carrier substrate, the electrically conductive material forming at least one transmitter coil, wherein the carrier substrate with the mounted electrically conductive material is formed to adapt to a ceiling, wherein the at least one transmitter coil is configured to transmit an electromagnetic field for powering at least one of a wearable electronic device and a second wearable electronic device.

Such a ceiling-mountable power transmitter provides the following advantages: the transmitter can be placed under the ceiling, e.g., directly under the ceiling or mounted at a wall close to the ceiling, and can be used in most places, environments and possible scenarios, provided that it can be plugged to the main line. The transmitter allows the user to freely move on a designated space, for example, under a panel of the ceiling, while using and continuously supplying the battery of an electronic device.

In this context, the term “ceiling-mountable” means that the transmitter can be mounted under the ceiling, e.g., by direct attachment to the ceiling or attachment to the ceiling walls or even by embedding in the ceiling, e.g., into a ceiling panel or by attachment to a ceiling panel. In particular, the term “ceiling-mountable” means that the transmitter can be mounted over the head of a user such that a distance to the head of the user is low in order to allow an efficient power transmission from the power transmitter to a power receiver worn at a head area of the user.

In an implementation of the ceiling-mountable power transmitter, the ceiling-mountable power transmitter comprises a shielding material mounted at the carrier substrate, the shielding material being configured to shield the ceiling from the power transmitter and vice versa.

Such a ceiling-mountable power transmitter provides the advantage of an effective shielding of the ceiling from the power transmitter.

The carrier substrate may comprise a first surface configured to face the ceiling and a second surface opposing the first surface. The shielding material may be mounted at the first surface of the carrier substrate, and the electrically conductive material forming the at least one transmitter coil may be mounted at the second surface of the carrier substrate.

In an implementation of the ceiling-mountable power transmitter, the ceiling-mountable power transmitter comprises substrate extensions located at corners of the carrier substrate, the substrate extensions being displaced in height with respect to a main plane of the carrier substrate, wherein the at least one transmitter coil is formed on the carrier substrate and on the substrate extensions.

This provides the advantage of an increased uniformity of the generated electromagnetic field distribution in a direction perpendicular to the main plane.

In an implementation of the ceiling-mountable power transmitter, the at least one transmitter coil is configured to generate at least two charging hotspots for powering at least a wearable electronic device and a second wearable electronic device.

This provides the advantage that the transmitter can efficiently and simultaneously power two wearable electronic devices, each be a respective hotspot and/or the transmitter can supply to receivers worn by a second user.

In an implementation of the ceiling-mountable power transmitter, the carrier substrate with the mounted electrically conductive material and with or without the shielding material is formed to be embedded in a panel attachable to the ceiling or to be embedded into the ceiling.

This provides the advantage that the transmitter can efficiently mounted in the ceiling, hence providing a comfortable use for the user.

The ceiling-mountable power transmitter may comprise a housing for housing the carrier substrate with the mounted electrically conductive material and with or without the shielding material and the power source.

The ceiling-mountable power transmitter may comprise a user interface for remote controlling the ceiling-mountable power transmitter.

According to a fifth aspect, embodiments of the disclosure relate to a method for powering a wearable electronic device, the method comprising: enabling a ceiling-mountable power transmitter according to the fourth aspect; detecting, by the ceiling-mountable power transmitter, one or more wearable wireless power receivers according to the first aspect; upon detecting a wearable wireless power receiver according to the first aspect, providing, by the ceiling-mountable power transmitter, an initial power to the wearable wireless power receiver for communicating a pairing mode between the ceiling-mountable power transmitter and the wearable wireless power receiver; and providing, by the ceiling-mountable power transmitter, a nominal power to the wearable wireless power receiver for powering at least one of a wearable electronic device and a second wearable electronic device.

Such a method provides the same advantages as the wearable wireless power receiver, the wireless power receiver arrangement, and the ceiling-mountable transmitter described above. i.e., it provides the advantage of an efficient wireless power transmission of wearable electronic devices that is comfortable for the user. The method allows for a continuous powering of electronic devices that are intended to be worn by the user while allowing him to freely move on a designated space while using the device.

In the following, advantages and advantageous effects are described which can be achieved by the devices, method, systems and arrangements described in this disclosure.

The disclosed devices, method, systems and arrangements and all the disclosed modules in combination, that is, the WPT system for dynamic scenarios and in particular the disclosed transmitter-receiver system; the ceiling-mountable WPT transmitter device and the WPT receiver device worn on the user's head area provide the following advantages: They allow to provide continuous power supply to receiver devices subjected to a high-dynamic range while being worn by the user, in particular to head-mounted devices like extended reality headsets. They avoid having to carry a heavy battery bank to continuously supply the device being used. They allow to reduce the battery size and consequently to reduce the overall size and weight of the device to be charged, resulting in a more portable, compact and comfortable fit. The problem of large variation coupling factor to which any dynamic scenario is subjected is solved by employing a wireless power transfer system working under the magnetic resonant wireless power transfer principle.

A ceiling-mountable transmitter device according to the disclosure and a suspended panel or planar feature of the transmitter device provide the following advantages: The transmitter device can be placed under the ceiling and can be used in a variety of places, environments and possible scenarios, provided that it can be plugged to the main line. The transmitter device allows the user to freely move on a designated space, for example, under the panel, while using and continuously supplying the battery of an electronic device.

A head-wearable receiver device according to the disclosure allows the user to freely move on a designated space while using and continuously supplying the battery of an electronic device. It allows the receiver to be fitted into a helmet-like accessory and be worn comfortably and safely without constraining the user.

A power distribution/delivery module according to the disclosure allows for an easy mount, to be worn close to the user's body allowing him to freely move without constraints. It allows the power to be distributed all the way from the head of the user to the device requiring charge. In some implementations directly to a head-mounted device, like extended reality headsets. In some other implementations requiring an external processing unit such as a smartphone, the distribution can happen before the power conversion step and travel in a first step from the head of the user to the user's pocket or wherever such unit is carried and in a second step from the processing unit to the device requiring charge such as a head-mounted device. The power distribution can happen in the DC or in the AC domain by the user of a cable or a coupled resonator array. Such a power distribution/delivery module according to the disclosure allows to provide power to multiple receiver devices simultaneously.

### BRIEF DESCRIPTION OF THE DRAWINGS

Further embodiments of the disclosure will be described with respect to the following figures, in which:

FIG. 1 shows a schematic diagram of a wireless power transfer system 100 according to an embodiment of the disclosure;

FIG. 2 shows a circuit diagram of the wireless power transfer system 100 shown in FIG. 1;

FIG. 3(a) shows a schematic diagram illustrating the wireless power transfer system 100 according to an embodiment of the disclosure, and FIGS. 3(b), 3(c) and 3(d) show schematic diagrams illustrating different examples of a ceiling-mountable power transmitter;

FIGS. 4(a), 4(b) and 4(c) show schematic diagrams illustrating three embodiments of the wireless power transfer system 100 shown in FIG. 1;

FIGS. 5(a), 5(b) and 5(c) show schematic diagrams illustrating a detailed implementation of the wireless power transfer system 100 shown in FIG. 1;

FIGS. 6(a), 6(b) and 6(c) show schematic diagrams illustrating another detailed implementation of the wireless power transfer system 100 shown in FIG. 1;

FIGS. 7(a), 7(b), 7(c) and 7(d) show schematic diagrams illustrating a further detailed implementation of the wireless power transfer system 100 shown in FIG. 1;

FIG. 8 shows a schematic diagram illustrating a scenario where a user is playing a virtual reality game according to an embodiment of the disclosure;

FIGS. 9(a) and 9(b) show schematic diagrams illustrating a scenario for assisting a user to perform a certain task with the use of an extended reality headset according to an embodiment of the disclosure;

FIGS. 10(a) and 10(b) show schematic diagrams illustrating implementations of a ceiling-mountable power transmitter according to an embodiment of the disclosure;

FIGS. 11(a) and 11(b) show schematic diagrams illustrating implementations of the shielded magnetic components on the transmitter and the receiver side according to an embodiment of the disclosure;

FIGS. 12(a) and 12(b) show implementations of the inductive element of the transmitter device, i.e., the ceiling-mountable power transmitter according to an embodiment of the disclosure;

FIG. 13 shows a schematic diagram illustrating an implementation of a wearable wireless power receiver 105 located on the head of the user according to an embodiment of the disclosure;

FIG. 14 shows a schematic diagram illustrating another implementation of a wearable wireless power receiver 105 located on the head of the user according to an embodiment of the disclosure;

FIGS. 15(a), 15(b), 15(c), 15(d) and 15(e) show schematic diagrams illustrating an implementation of a wireless power transfer system with a wearable coupled resonator array 402 according to an embodiment of the disclosure;

FIGS. 16(a) and 16(b) show schematic diagrams illustrating an implementation of a wireless power transfer system 100 for providing wireless power to intermediate devices according to an embodiment of the disclosure; and

FIG. 17 shows a schematic diagram illustrating a method 1700 for powering a wearable electronic device according to an embodiment of the disclosure.

### DETAILED DESCRIPTION OF EMBODIMENTS

In the following detailed description, reference is made to the accompanying drawings, which form a part thereof, and in which is shown by way of illustration aspects in which the disclosure may be practiced. It is understood that other aspects may be utilized and structural or logical changes may be made without departing from the scope of the disclosure. The following detailed description, therefore, is not to be taken in a limiting sense, and the scope of the disclosure is defined by the appended claims.

It is understood that comments made in connection with a described method may also hold true for a corresponding device or system configured to perform the method and vice versa. For example, if a method step is described, a corresponding device may include a unit to perform the described method step, even if such unit is not explicitly described or illustrated in the figures. Further, it is understood that the features of the various aspects described herein may be combined with each other, unless noted otherwise.

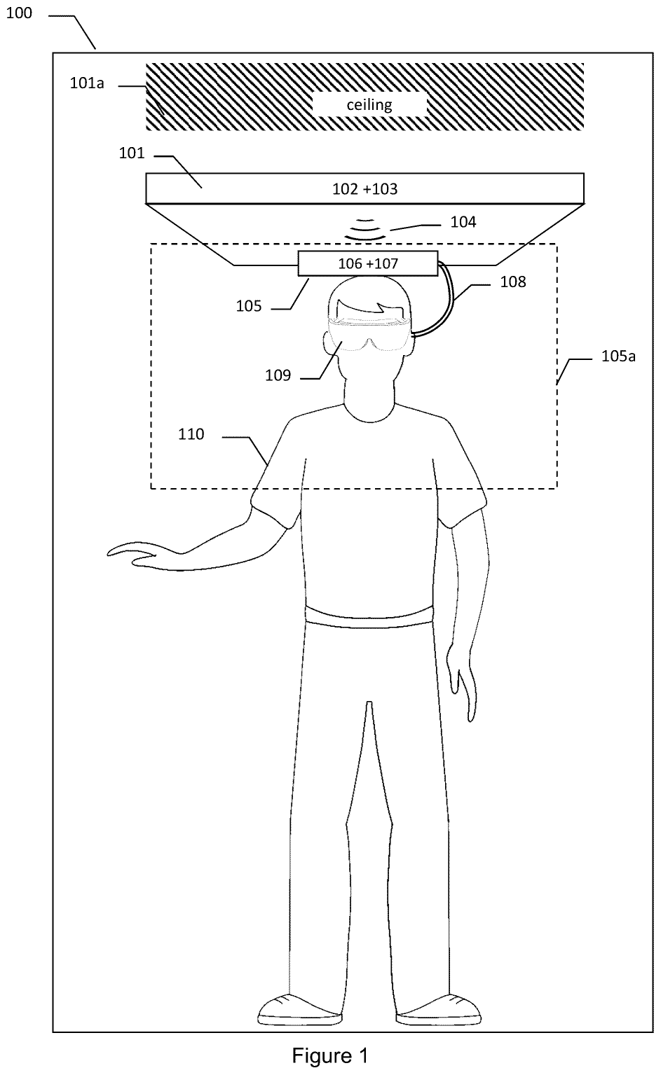

FIG. 1 shows a schematic diagram of a wireless power transfer system 100 according to the disclosure.

Such a wireless power transfer system 100 may comprise the following components as shown in FIG. 1:
a ceiling-mountable power transmitter 101 such as a wireless power transmitter device 101 to be suspended below the ceiling over the user's head. The transmitter device 101 comprises a power source 102 and at least one transmitter coil 103;
a wearable wireless power receiver 105 that can be affixed to the head of the user 110. The receiver device 105 comprises a receiver coil 106 and may further comprise a power conversion module 107;
an electronic device 109, in particular a wearable electronic device 109 that can be mounted around the head area of the user 110. The wearable electronic device 109 requires power to either charge its battery or to be supplied continuously in implementations of the device 109 without a battery;
a power distribution medium 108, also referred hereinafter as an electric guide 108, from the wearable wireless power receiver 105 to the wearable electronic device 109.

FIG. 1 also shows a wearable wireless power receiver arrangement 105a that comprises the wearable wireless power receiver 105, the wearable electronic device 109 and/or a second wearable electronic device, and the electric guide 108.

The wireless power transfer system 100 can be used to provide power to the electronic device 109 worn while being in use or that is carried by a user 110. That means that the receiver device 105 is subjected to the dynamic motion from the user 110 within a defined space. This situation may arise, for example, when the user 110 has a battery driven extended reality headset 109 whose battery is depleting and needs to be charged but the user 110 requests to continue using the device 109. Such a scenario can arise when the user 110 is playing a virtual reality game for an extended period of time.

The wearable wireless power receiver 105 can be used for receiving an electromagnetic field 104 and transforming the electromagnetic field 104 into electric power for powering a wearable electronic device 109. The wearable wireless power receiver 105 may be configured for location at the head of the person 110.

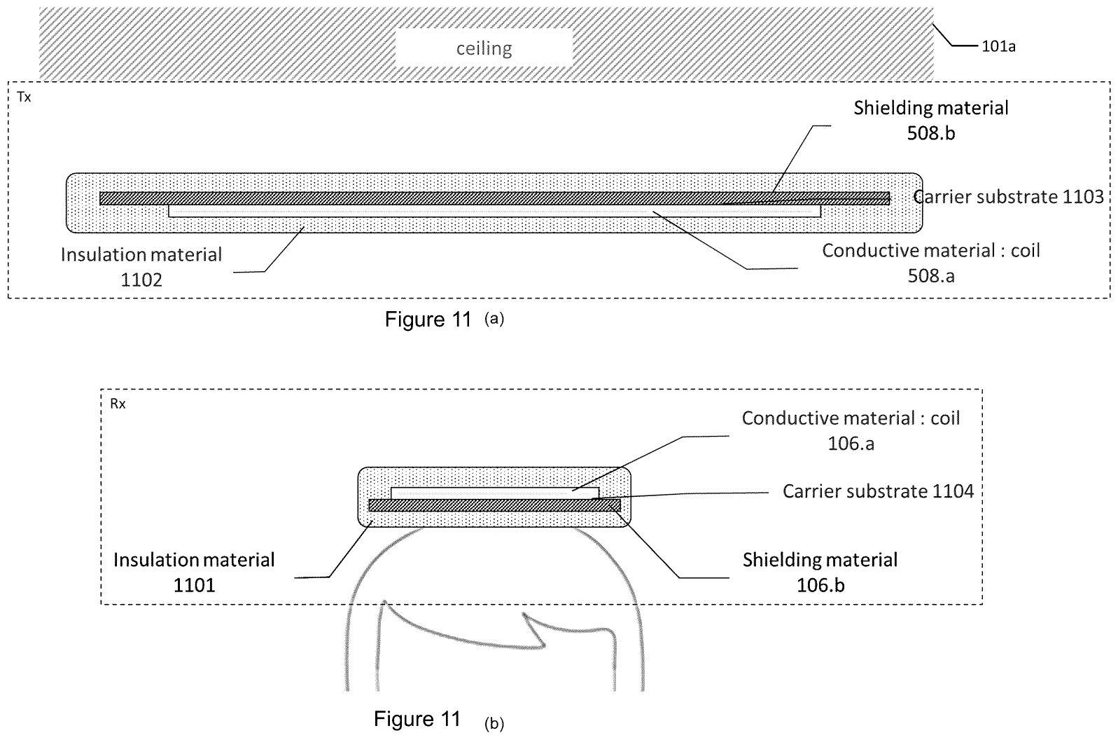

The wearable wireless power receiver 105 comprises: a carrier substrate 1104, e.g., as shown in FIG. 11; an electrically conductive material 106.a, also shown in FIG. 11, mounted at the carrier substrate 1104. The electrically conductive material 106.a is forming at least one receiver coil 106. The carrier substrate 1104 with the mounted electrically conductive material 106.a is formed to adapt to a head area of the person 110. The at least one receiver coil 106 is configured to receive an electromagnetic field 104.

In this context, the term “configured for location at the head” means that the wearable wireless power receiver 105 can be attached, fixed or embedded below, around, inside or within audio and or visual headsets or even headwear at the head of the person for example in a hat, a beanie or a helmet.

The wearable wireless power receiver 105 may comprise a shielding material 106.b, e.g., as shown in FIG. 11, mounted at the carrier substrate 1104. The shielding material 106.b may be configured to shield the head of the person 110 from at least a portion of the electromagnetic field 104.

The carrier substrate 1104 may comprise a first surface configured to face the head of the person 110 and a second surface opposing the first surface. The shielding material 106.b may be mounted at the first surface of the carrier substrate 1104, and the electrically conductive material 106.a forming the at least one receiver coil 106 may be mounted at the second surface of the carrier substrate 1104.

The carrier substrate 1104 with the mounted electrically conductive material 106.a and with or without the shielding material 106.b may be formed to be removably attached at an upper part of a headwear or a headset device to be worn by the person 110.

The carrier substrate 1104 with the mounted electrically conductive material 106.a and with or without the shielding material 106.b may be formed to be embedded into a headwear to be worn by the person 110.

The carrier substrate 1104 with the mounted electrically conductive material 106.a and with or without the shielding material 106.b may be formed to be embedded into the wearable electronic device 109.

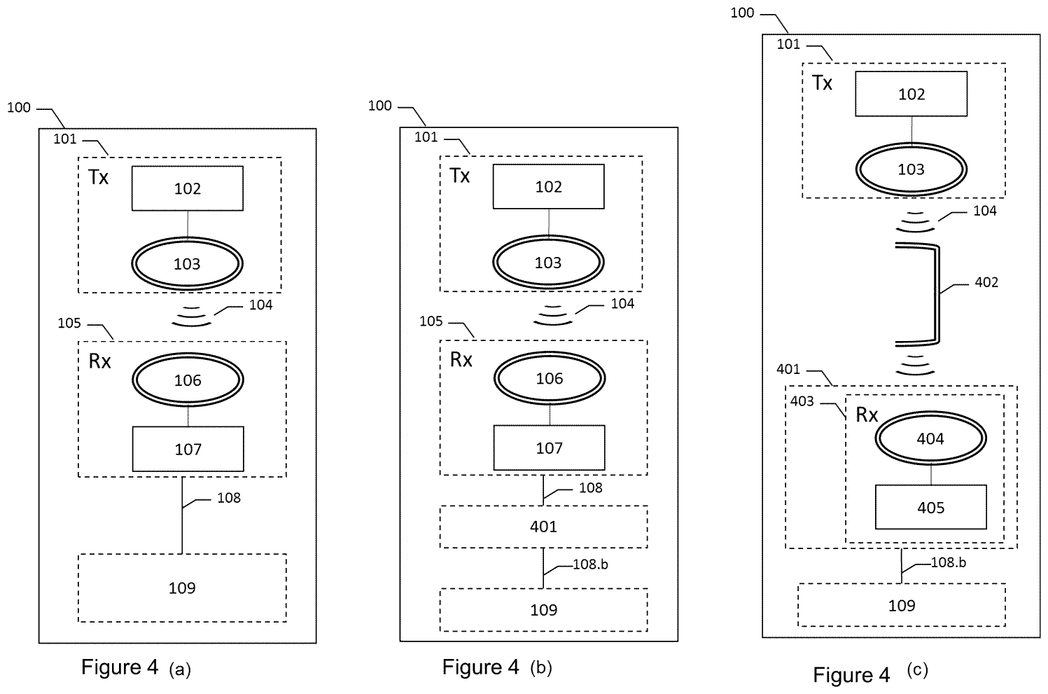

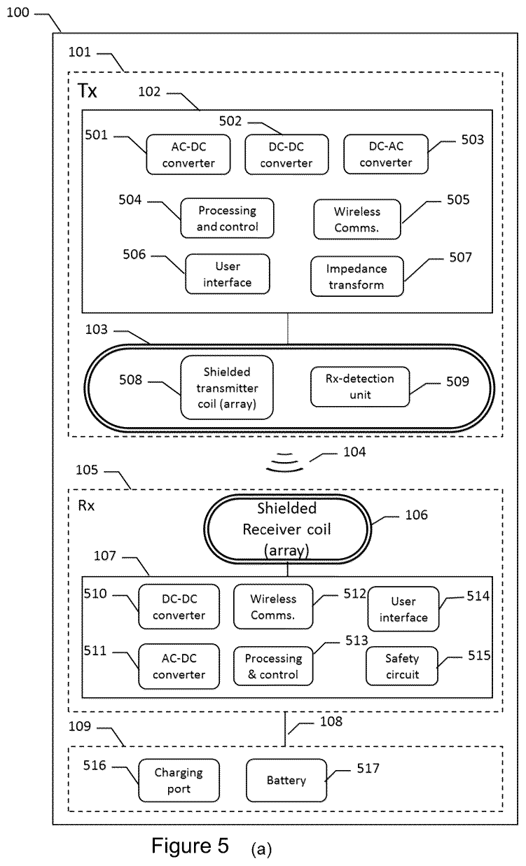

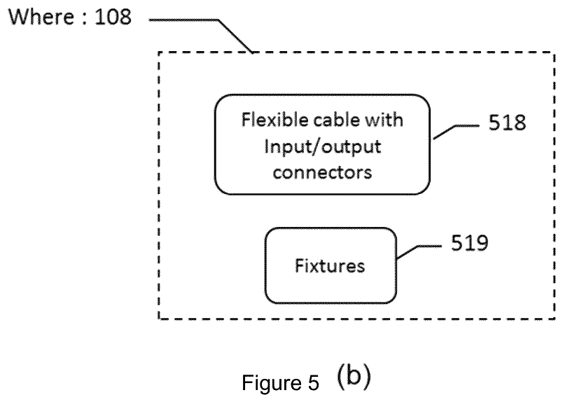

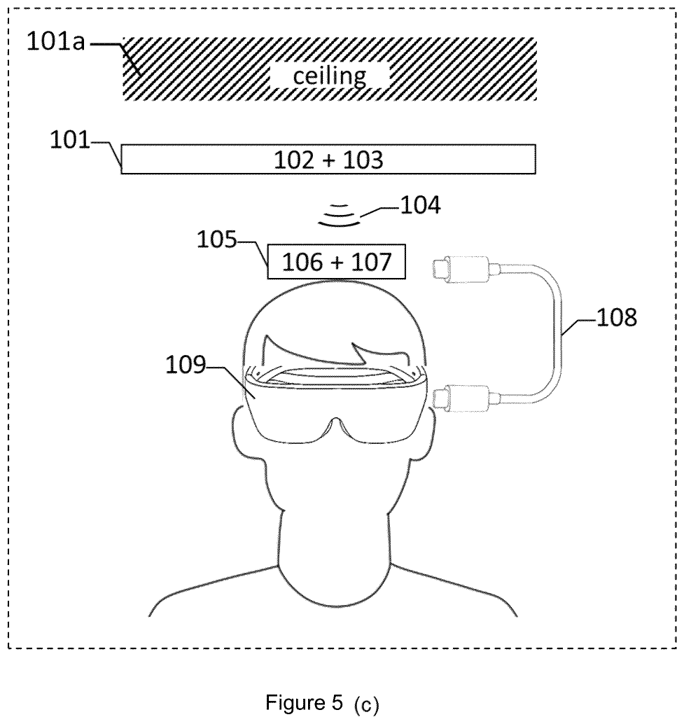

The wearable wireless power receiver 105 may comprise a power conversion entity 107, e.g. as shown in FIGS. 4(a), 4b, and 4c, and further explained in FIGS. 5a, 6b, and 7b configured to transform the electromagnetic field 104 received by the wireless power receiver 105 into electric power and to provide the electric power via an electric guide 108 to the wearable electronic device 109.

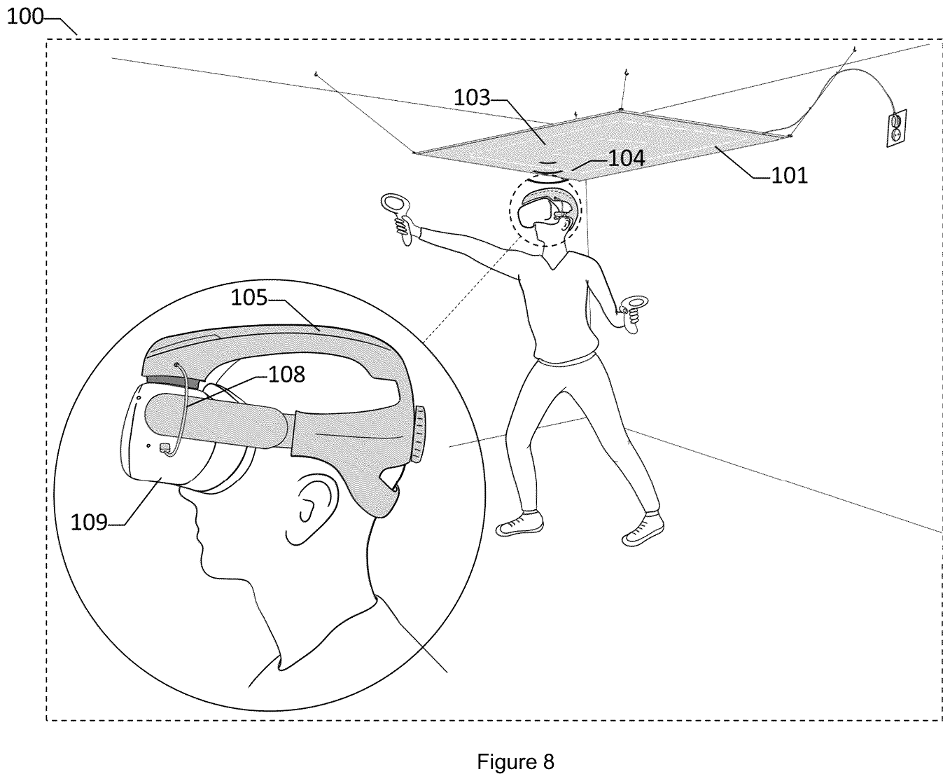

The wearable wireless power receiver 105 may comprise: an electrical connector for connecting an electrical cable as the electric guide 108, e.g. as shown in FIG. 8. The electrical connector may be configured to provide the electric power via the electrical cable 108 to the wearable electronic device 109.

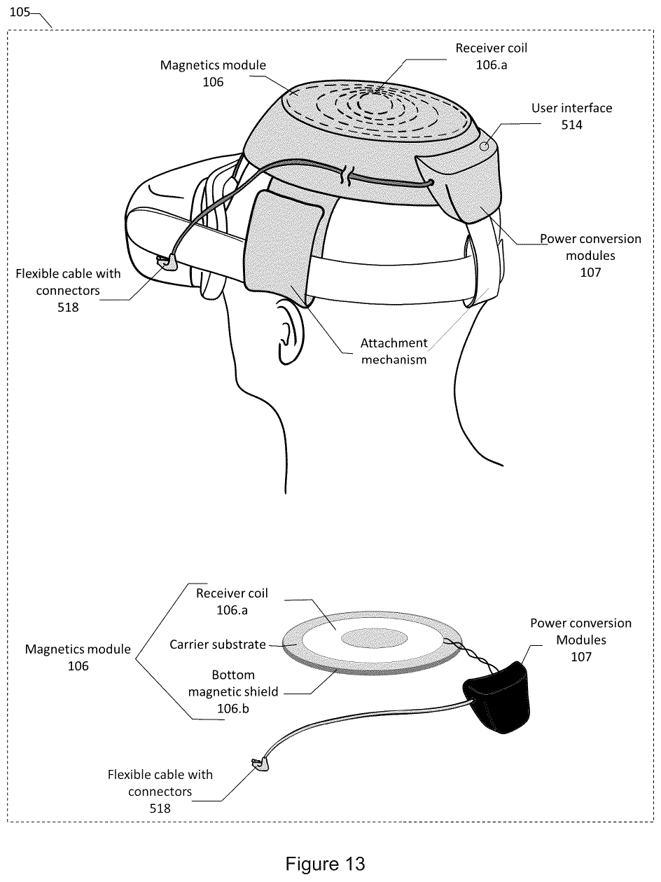

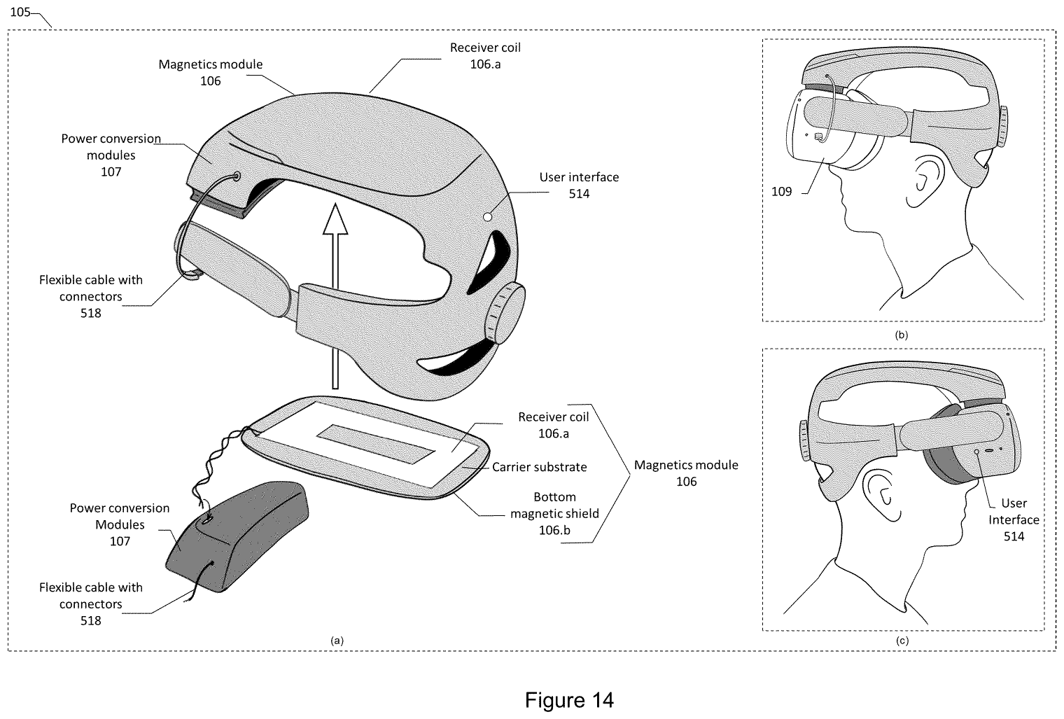

The wearable wireless power receiver device 105 may comprise a user interface 514, e.g., as shown in FIGS. 13 to 14, for displaying the status of the wireless power receiver.

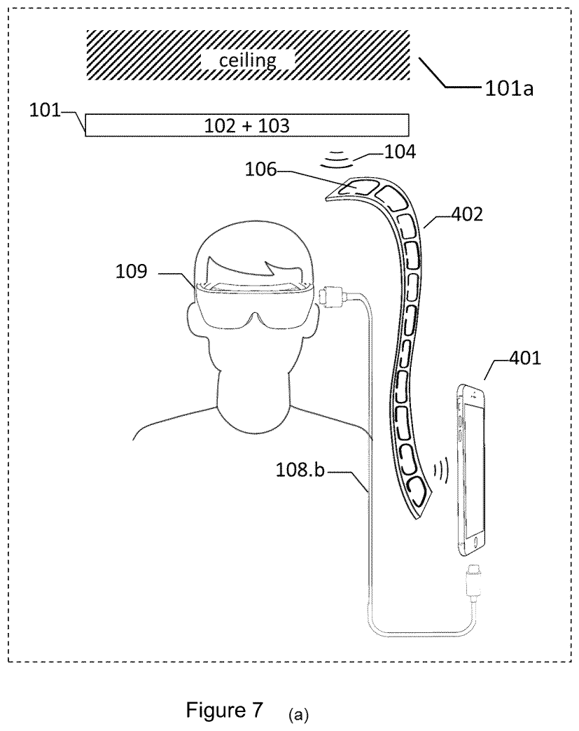

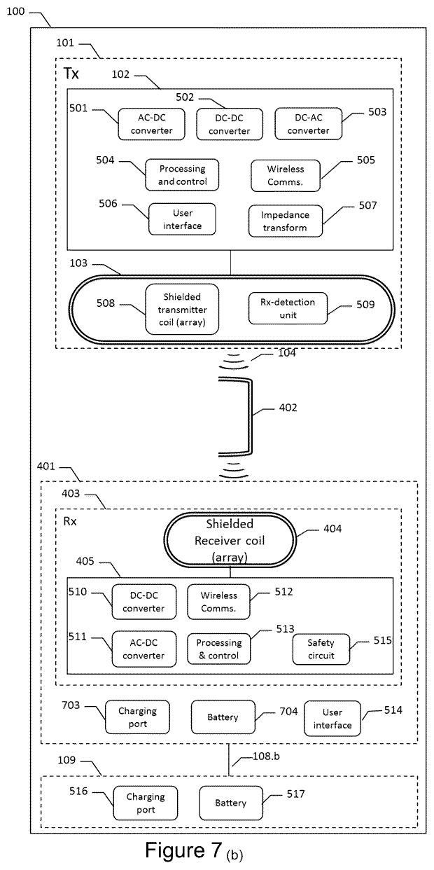

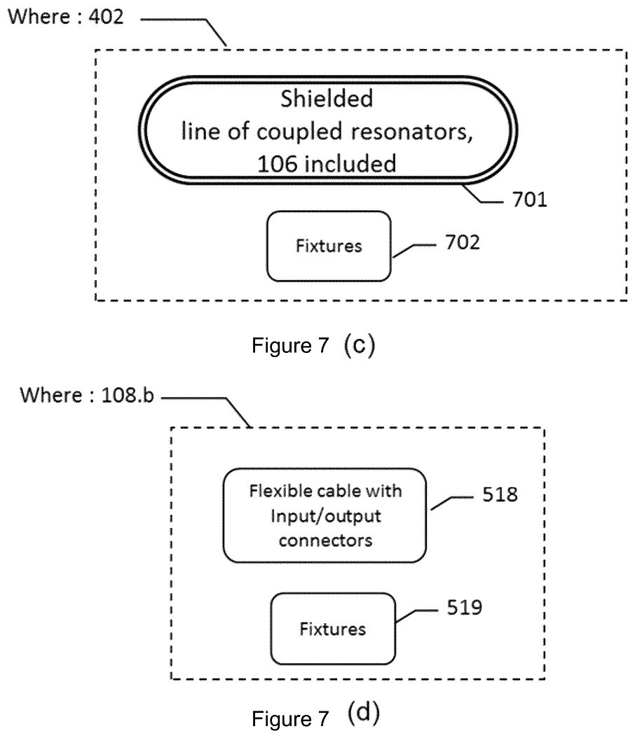

The wearable wireless power receiver device 105 can be included in a wearable coupled resonator array 402, e.g., as shown in FIGS. 7a, 7b, 15a, 15b, 15c, 15d and 16b. Such a wearable coupled resonator array 402 may be configured to extend from the head area of the person 110 to a location of the wearable electronic device 109 or to a location of a second wearable electronic device 401. The wearable coupled resonator array 402 may be configured to receive an electromagnetic field 104 and to relay it from the head area of the person 110 to the location of the wearable electronic device 109 or to the location of the second wearable electronic device 401.

The wearable electronic device 109 and/or the second wearable electronic device 401 may comprise a wireless power receiver entity 403 of its own, e.g., as shown in FIG. 7b, that may be configured to receive the electromagnetic field 104 from the coupled resonator array 402.

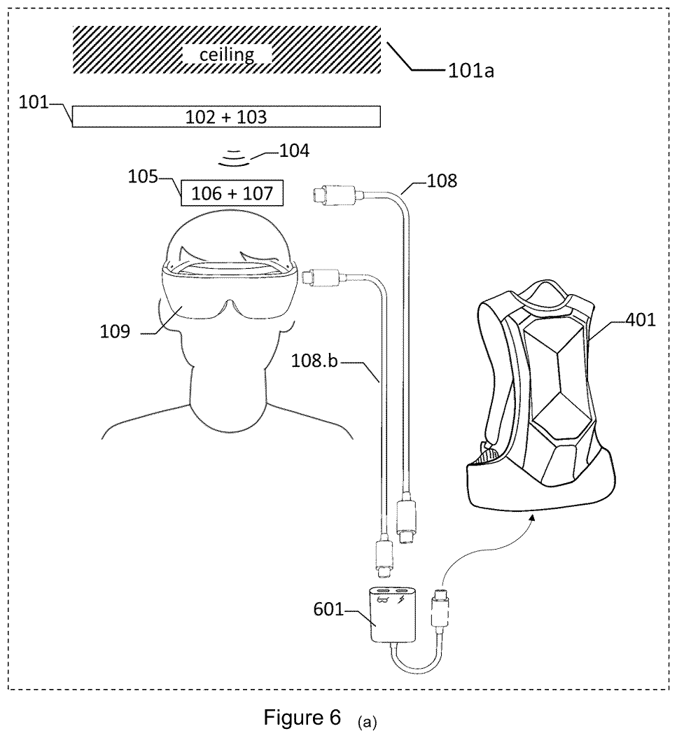

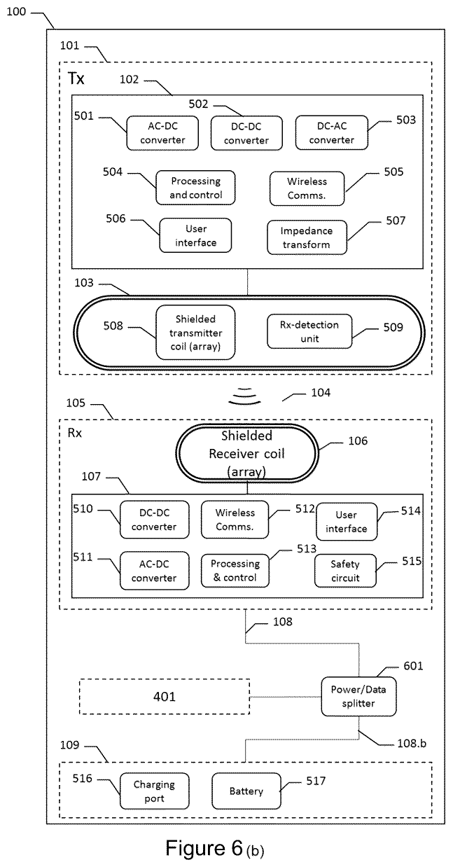

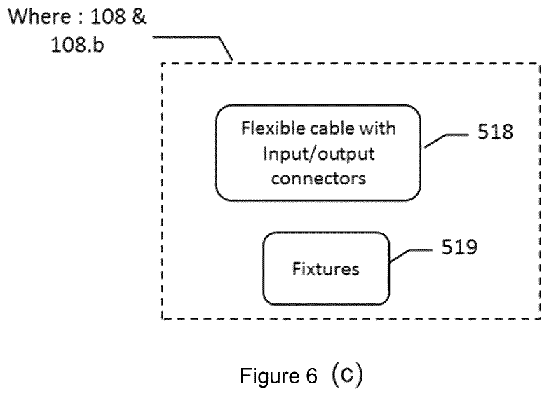

The wearable wireless power receiver arrangement 105a shown in FIG. 1 can be used for powering at least one of a wearable electronic device 109 or a second wearable electronic device 401, e.g., as shown in FIGS. 6a, 6b, 7a, 7b. The wearable wireless power receiver arrangement 105a comprises: a wearable wireless power receiver 105 as described above, or a wearable coupled resonator array 402 as described above; a wearable electronic device 109 and/or a second wearable electronic device 401 configured to be powered by the wearable wireless power receiver 105. The wearable wireless power receiver arrangement 105a comprises an electric guide 108, 108.b that may be configured to transport the electric power from at least one of the wearable wireless power receiver 105 and the second wearable electronic device 401 to at least one of the wearable electronic device 109 and the second wearable electronic device 401.

The second wearable electronic device 401 may be configured to charge itself with part of the electric power and forward the rest of the electric power received via a first electric guide 108 from the wearable wireless power receiver 105 via a second electric guide 108.b to the wearable electronic device 109, e.g., as shown in FIGS. 4(b), 4c, 6a, 6b, 6c, 7a, 7b, 7d.

The second wearable electronic device 401 may comprises a wireless power receiver entity 403, e.g., as shown in FIG. 4c or 7b, that may be configured to: receive the electromagnetic field 104 from a coupled resonator array 402, convert the electromagnetic field 104 into electric power, charge itself with part of the electric power, and/or forward the remaining part of the electric power via an electric guide 108.b to the wearable electronic device 109.

The ceiling-mountable power transmitter 101 shown in FIG. 1 can be used for powering at least one of a wearable electronic device 109 and a second wearable electronic device 401 through the use of a wearable wireless power receiver arrangement 105a as shown in FIG. 1 and described above.

The ceiling-mountable power transmitter 101 comprises: a power source 102; a carrier substrate 1103, e.g., as shown in FIG. 11a; an electrically conductive material 508.a mounted at the carrier substrate 1103. The electrically conductive material 508.a is forming at least one transmitter coil 103. The carrier substrate 1103 with the mounted electrically conductive material 508.a is formed to adapt to a ceiling 101a as shown in FIG. 1. The at least one transmitter coil 103 is configured to transmit an electromagnetic field 104 for powering at least one of a wearable electronic device 109 and a second wearable electronic device 401.

The ceiling-mountable power transmitter 101 may comprise a shielding material 508.b, e.g., as shown in FIG. 11a, mounted at the carrier substrate 1103. The shielding material 508.b may be configured to shield the ceiling 101a from the power transmitter 101 and vice versa.

The carrier substrate 1103 may comprise a first surface configured to face the ceiling 101a and a second surface opposing the first surface. The shielding material 508.b may be mounted at the first surface of the carrier substrate 1103, and the electrically conductive material 508.a forming the at least one transmitter coil 103 may be mounted at the second surface of the carrier substrate 1103.

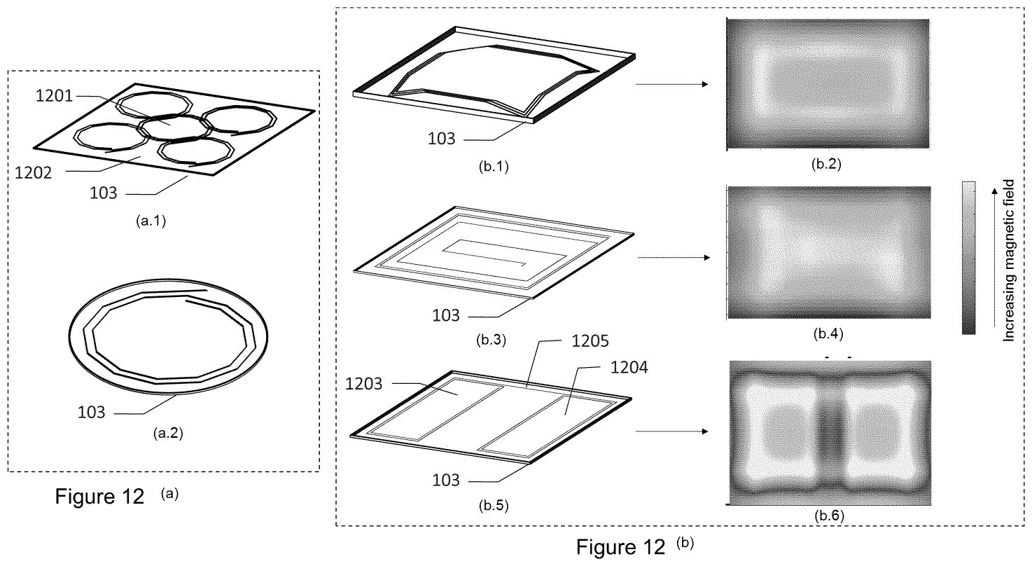

The ceiling-mountable power transmitter 101 may comprise substrate extensions located at corners of the carrier substrate 1103, e.g., as shown in FIG. 12b.1. The substrate extensions can be displaced in height with respect to a main plane of the carrier substrate 1103. The at least one transmitter coil 103 may be formed on the carrier substrate 1104 and on the substrate extensions.

The at least one transmitter coil 103 may be configured to generate at least two charging hotspots, e.g. as shown in FIG. 12b.5 for powering at least a wearable electronic device 109, 401 and a second wearable electronic device 109, 401.

The carrier substrate 1103 with the mounted electrically conductive material 508.a and with or without the shielding material 508.b may be formed to be embedded in a panel attachable to the ceiling 101a or to be embedded into the ceiling 101a.

The ceiling-mountable power transmitter 101 may comprise: a housing for housing the carrier substrate 1104 with the mounted electrically conductive material 508.a and with or without the shielding material 508.b and the power source 102.

The ceiling-mountable power transmitter 101 may comprise: a user interface 506, e.g., as shown in FIGS. 5a, 6b, 7b 10a, and 10b, for displaying its status and/or remote controlling the ceiling-mountable power transmitter 101.

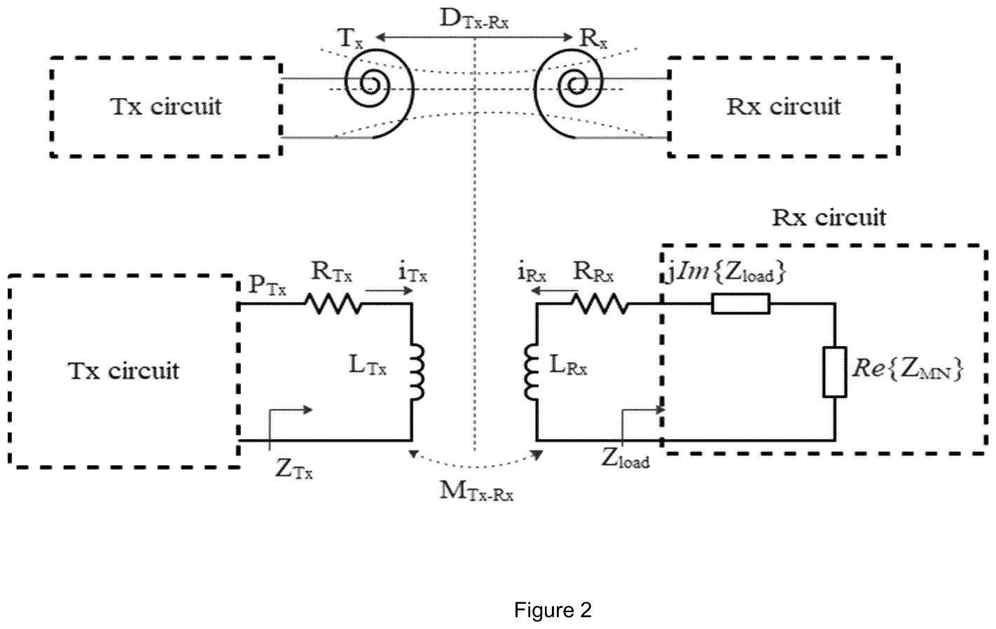

Such a wireless power transfer system 100 as described above with respect to FIG. 1, allowing the dynamic range is depicted in FIG. 2, which shows a system in which the power is transferred from the transmitter circuit to the receiver circuit by means of a magnetic resonant link. In actuality, each coil is made up of its desired characteristic, its self-inductance, as well as a few undesirable components that can be grouped into resistive and capacitive components. For the purpose of simplicity, no parasitic capacitors of the transmitter and receiver coils are considered in this model. The lumped parasitic resistances of the inductances L_{Tx} and L_{RX}, which model the losses in their windings, are R_{Tx} and R_{Rx}, respectively. The transmitter and receiver coils, separated by an arbitrary distance D_{Tx-RX} have a mutual inductance of M_{Tx-RX}, which is determined by their geometry, relative position and orientation.

The input impedance of the Rx-circuit is denoted in this figure as Z_{load}, which can be composed by a real part and an imaginary part. Z_{load} can represent, for instance, a load connected directly to the receiver resonator or it can arise from a subsequent part of the power conversion chain in the receiver device, for example from a rectifier circuit and a DC-DC converter.

When considering that the wireless power transmission between the transmitter and the receiver resonators happens in the near-field of the transmitter, there are no radiation effects included. Therefore, all the losses in the system occur due to the parasitic resistances of the transmitter and the receiver coils, R_{Tx} and R_{RX}. In this manner, the power supplied by the transmitter circuit (Tx-circuit) is delivered to the receiver circuit (Rx-circuit) affected by the coils' mutual inductance and it is dissipated as heat in the equivalent series resistances of the coils.

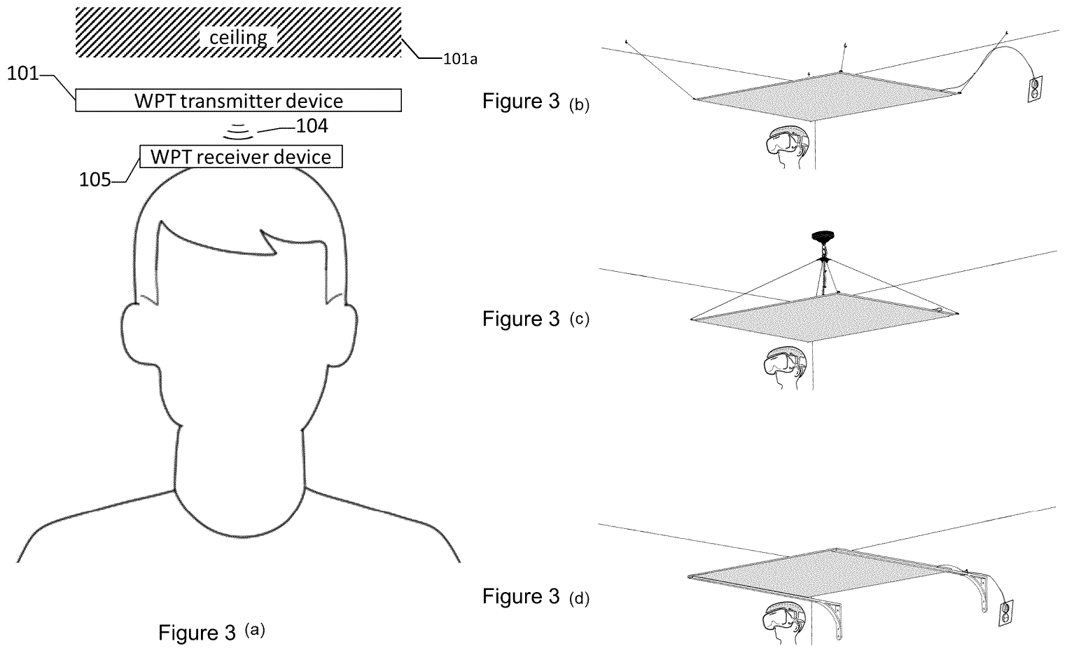

The wireless power transfer system circuit diagram of FIG. 2 can be translated into the application scenario of FIG. 1 by the usage of the components found in FIG. 3. A wireless power transmitter device located below the ceiling and over the user's head with a certain gap, as shown in FIG. 3a, provides wireless power to a receiver worn on the head of the user. The receiver device is subjected to motion but within a defined area and in close proximity to the transmitter ensuring a large enough mutual inductance between the two resonator circuits.

The wireless power receiver device located on the head of the user can be fixed or placed on the electronic device 109 mounted around the head area of the user that requires power, as depicted in FIG. 1.

The wireless power transmitter device can be hung from the ceiling as shown in FIG. 3b, 3c or fixed to a wall as shown on FIG. 3d.

The solution presented in this disclosure is applicable to wireless power receiver devices like smartphones, wearables like smartwatches, fitness bands, extended reality headsets and hand-controllers, over-ear headphones, tablets, portable computers, smart glasses, gaming controllers, remote controls, hand-held terminals, portable gaming consoles, portable music players, used in wireless power transfer systems that the user requests to use the device while charging it.

A typical use case for the solution described herein is that an electronic device worn by the user is supplied while the user is under a certain structure located on top of him. Such a scenario can include the use of a wireless power transfer system as described in this disclosure.

FIG. 4 shows three wireless power transfer systems of the disclosed technology in FIG. 1. The system of FIG. 4a comprises a wireless power transmitter device 101 and at least one wireless power receiver device 105. The wireless power transmitter device comprises a power source 102, a magnetics module 103 comprising at least one transmitter coil forming a resonant circuit in conjunction with an external capacitance as exemplified in FIG. 2.

The wireless power transmitter device is operated to produce a closed electrical circuit for electrons to flow through and to generate an electromagnetic field 104 that emanates from the transmitter device; wherein the wireless power transmitter device 101 is operated to wirelessly power or charge electric or electronic device(s) 109 by providing the produced electromagnetic field by the magnetics module 103 to a receiver coil or coil array 106 into electrical energy by the use of a power conversion module 107 and provide the converted power to the electronic device 109 through a power distribution media 108.

In order to use the power coming from the transmitter device, the wireless power enabled-receiver receives the power coming from the transmitter, converts it from an AC to a DC signal using the power conversion module 107, then the power is distributed through the power distribution media 108 to the device requiring charge 109. In some other implementations, like the one depicted in FIG. 4b, the power distribution can happen twice, first using the distribution medium 108 to provide the power to an intermediate electronic device 401 such as a smartphone providing external processing power, and then using a second power distribution medium 108.b to provide power to the end electronic device 109. In some other implementations, like the one depicted in FIG. 4c the power distribution can happen before the power conversion step. According to the embodiment of FIG. 4c the power distribution medium can guide the received electromagnetic field 104 through the medium 402 to the intermediate electronic device 401 which is fitted with a wireless power receiver device 403 and then further provide the received power to the end electronic device 109 through a power distribution medium 108.b.

FIG. 5. shows a detailed possible implementation of the wireless power transfer system of FIG. 1 and further explains the modules of the system of FIG. 4a. The wireless power supply 102 comprises, the AC power source 503 of the wireless power transmitter device 101. This power source may be connected to the output of a DC-DC converter 502, in order to extract the required power for its function from a DC power source, such as a battery in the transmitter device. In some other implementations the transmitter device may also have the possibility to extract the required power for its function from an AC-DC converter 501, such as a circuit that converts the AC power of the line into a DC power. The transmitter device may also include an impedance transformation circuit 507 that is capable of transforming the output impedance of the DC-AC converter 503 from one value to another value. Such a transformation unit is useful for impedance matching in order to transfer optimum power to the receiver device. The power supply 102 being connected to a magnetics module 103 comprising at least one transmitter coil 508 and a receiver detection unit 509. As explained by FIG. 2, the combination of an inductive element 508 and a capacitance form a resonant inductive-capacitive resonator circuit capable of generating an electromagnetic field 104.

The wireless power transmitter 101 can be capable of adjusting the wireless power transfer by the use of the processing and control unit 504, for example, by operating it to change the characteristics of the AC source 503 like changes in the magnitude, phase or frequency or combinations of thereof to generate a change in the electromagnetic field 104 that emanates from the transmitter device 101 to wirelessly power and charge electric or electronic device(s) 105 and 109 or by operating the impedance transformation network 507. These possible changes can be achieved with the use of a receiver detection unit 509 that is directly affected by a possible change in the coupling conditions of the at least one receiver 105 with respect to the transmitter 101. For example, when a receiver device is moved from a previous to a new location, because of the electromagnetic coupling 104 that exists between the receiver coil or coil array 106 and the transmitter coil or coil array 508, there will be a change reflected on the transmitter coil or coil array 508 by a change in the impedance with which the receiver device 105 loads the wireless power transmitter 101.

For example, in the case where the receiver 105 is composed by one single resonator with a total impedance of Z_{Rx} and that it is connected to a load R_{L} in series, the impedance “reflected” Z_{reflected} to the transmitter coil 508 is given by:

$${Z}_{reflected} = \frac{{ω}^{2} {M}_{R x \to T x}^{2}}{{Z}_{R x} + {R}_{L}} \qquad ( 1 )$$

where ω is the angular operation frequency and M_{Rx→Tx} is the mutual inductance between the single receiver resonator and a given transmitter resonator. The receiver detection unit can be implemented by a bi-directional coupler connected as a reflectometer and that in turn is connected to an RF detector circuit. The power detection unit may be comprised by other voltage/current/impedance/power sensitive circuit that will be directly affected by (1) for a changing coupling condition of the receiver(s). Note that even when the receiver device 105 did not undergo a change in position or orientation, (1) can still be affected when a change in the load of the receiver device, that is, the electronic device 109, occurred.

The processing and control unit 504 can also be affected by the information coming from a possible wireless communication unit 505 in the transmitter device 101 which is capable to wirelessly communicate to the wireless communication unit 512 in the receiver device 105 through electromagnetic waves. The two wireless communication units may exchange information via two distinct transducers compatible with, but not limited to Bluetooth, BLE, ZigBee, WiFi, WLAN, Thread, cellular communications like 2G/3G/4G/5G/LTE, NB-IoT, NFC, RFID, WirelessHART, among others. On the receiver device 105, the wireless communication unit 512 may aid in controlling the power conversion modules 511 and 510 via its own data processing and control unit 513 that may be present in the receiver device 105. There can be a script running inside 513 capable of gathering the relevant information related to the coupling conditions of the receiver(s) and other information like the level of the charge of the battery 517 in the electronic device 109 connected to the receiver device 105 by means of the power distribution medium 108.

The receiver device 105 can have a single coil or an arrangement of coils 106 acting as the inductive element(s) of an inductive-capacitive resonator(s). In some implementations, the receiver device 105 may be connected to an AC-DC converter 511, for example a rectifier that converts the alternating current (AC) to a direct current (DC) if the device to be powered by the application requires DC, such as the case of delivering DC power to an electronic device. In some other implementations, there can be a circuit 510 to convert a DC power level to another DC power level, such as a DC-DC converter or a charging circuit used to regulate the power delivered to the electronic device 109. The receiver device further comprises a safety circuit 515 capable of avoiding a fault operating mode by interrupting the power delivery to the device 109.

Both the transmitter and receiver device can include a user interface, 506 and 514 to help the user of the devices know that the power transfer is commencing or taking place as well as any other possible fault operating state. The user interface 506 can be partially implemented on the outside of the transmitter device and it would allow the user to turn on/off the transmitter device via a signal generated by a remote-control device like an infrared beam or via mobile device like wireless communication signal sent through Bluetooth or WiFi from a mobile device like a smartphone to the wireless communication module 505 transmitter device 101.

The power distribution medium 108 is further explained in FIG. 5b. The distribution media may include a flexible insulating material fitted with an electrical conductor as well as input and output connectors 518 and some fixture structures 519 that allow to fix the receiver 105 and distribution medium to the user's head or directly to the electronic device 109 requiring power in order to ensure a comfortable and safe connection between the two.

FIG. 5c shows a possible implementation of the system disclosed in FIG. 5a, FIG. 5b for the power delivery to a head-mounted device 109 with the use of the wireless power transmitter 101, the receiver 105 and the power distribution medium 108.

FIG. 6 shows another detailed possible implementation of the disclosed technology and further explains the modules of the system of FIG. 4b. FIG. 6a depicts how wireless power being generated by the transmitter device 101 is received by the receiver device 105 where it is converted into electrical energy to provide power to two devices, the intermediate device 401 through the power distribution medium 108 and to the end device 109 through the power distribution medium 108.b by employing a splitter element 601. The intermediate device 401 can be for example, a device that allows to increase the data processing features on the end-device 109. Such devices can be the user's smartphone or a wearable computer. FIG. 6b further clarifies the power flow from the transmitter to the receiver and the two electronic devices, 401 and 109. In such an implementation, there are two power distribution media, 108 and 108.b and a data/power splitter 601. FIG. 6c shows the power distribution media. The implementation in FIG. 6 is useful to provide the generated power by the transmitter device to devices that are not fitted with an enabled wireless power receiver device.

FIG. 7 shows a further implementation of the disclosed technology, explaining in detail the modules of the system of FIG. 4b. FIG. 7a depicts how the wireless power generated by the transmitter device 101 is guided through an array of coupled resonators 402 capable of guiding the electromagnetic field 104 generated by the transmitter device 101 to further increase its transmission range to the intermediate device 401. In this case, as further clarified by FIG. 7b, the intermediate device 401 is already fitted with a wireless power receiver device 403 capable of converting the received electromagnetic field into electrical energy suitable to charge the battery 704 on the intermediate device 401 as well as to deliver electrical power to the end electronic device 109 through the power delivery medium 108.b with purpose of charging the battery 517 by performing an electrical connection of the flexible cable 518 between the intermediate device 401 and the charging port 516 on the end device 109. FIG. 7c shows the power distribution medium 402 and FIG. 7d shows the power distribution medium 108.b. Note that the difference between the distribution medium is that 402 uses an array of coupled resonators guiding the energy electromagnetically, while 108.b guides the energy through an electrical connection.

The implementations disclosed in FIG. 5-7 can be used, for example, in the case where a user is playing a virtual reality game as exemplified in FIG. 8. FIG. 8 shows a possible embodiment of the transmitter, receiver, and power delivery medium in order to provide continuous power to the end-device, in this case a virtual reality headset 109. In this case, the user can move freely inside the defined area of the wireless power transmitter panel located on the top of his head and maintain the battery of the end-device 109 constantly charged provided that the user stays nearby the transmission range of the transmitter device. This will allow the user to be able to play continuously.

The disclosed technology can also make possible to use a battery of a smaller size thus reducing the overall weight of the end device, same that will translate into more comfort for the user. Note that provided that there is an energy storage element on the end device 109, for example a super capacitor, a battery will not be necessary altogether. In this case, the energy storage element will have to be able to provide to the electronic modules inside 109 long enough if the user were to momentary step out of the transmitter device's transmission range.

Note as well that while FIG. 8 employs a transmitter device 101 with the power source 102 and magnetics module 103 integrated as a single element, there can exist other implementations of the transmitter device 101 whose power source 102 and magnetics module 103 have been separated.

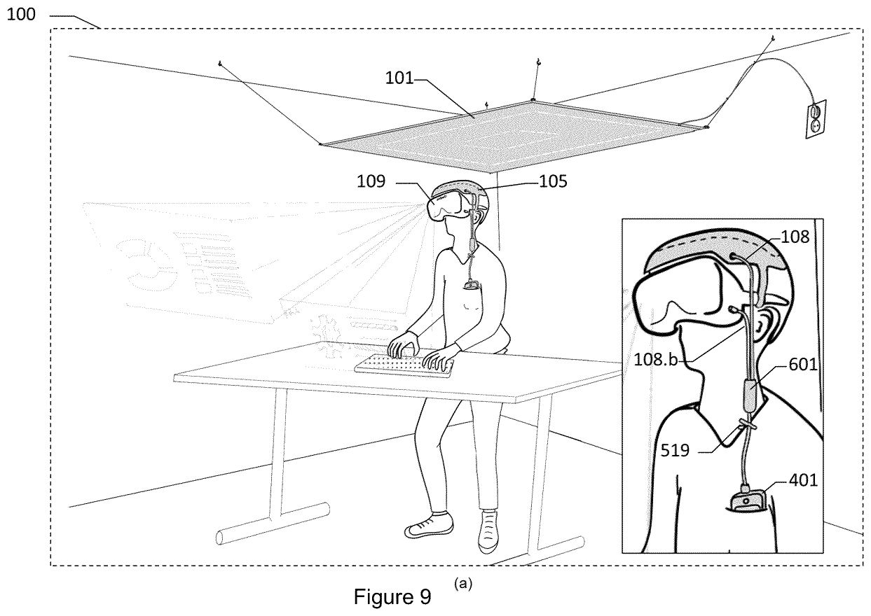

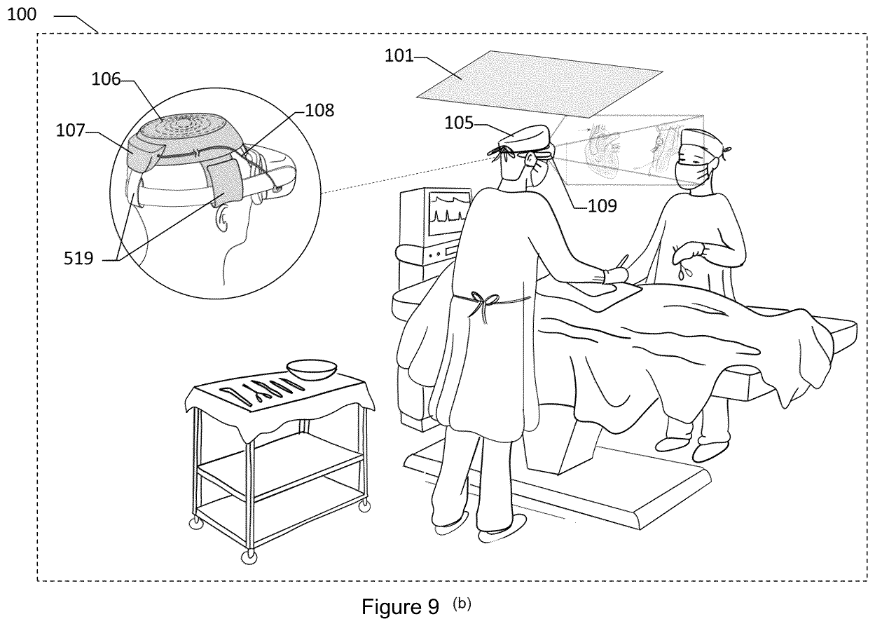

The implementations disclosed in FIG. 5-7 can be used, for example, to assist the user to perform a certain task with the use of an extended reality headset. FIG. 9a exemplifies the implementation disclosed in FIG. 6, where the wireless power transmitter device 101 can supply to an intermediate device 401 and to the end device 109. Both situations depicted in FIGS. 9a, 9b demonstrate the usefulness of the wireless power transfer system provided by this disclosure. Continuous wireless power transfer can be provided in situations in which the users request certain freedom of motion within a defined area for an extended period of time.

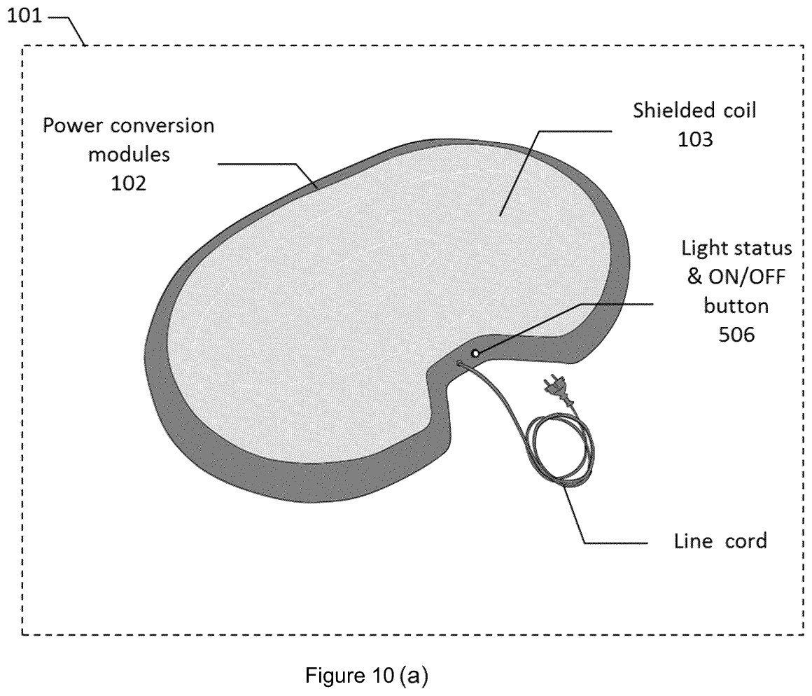

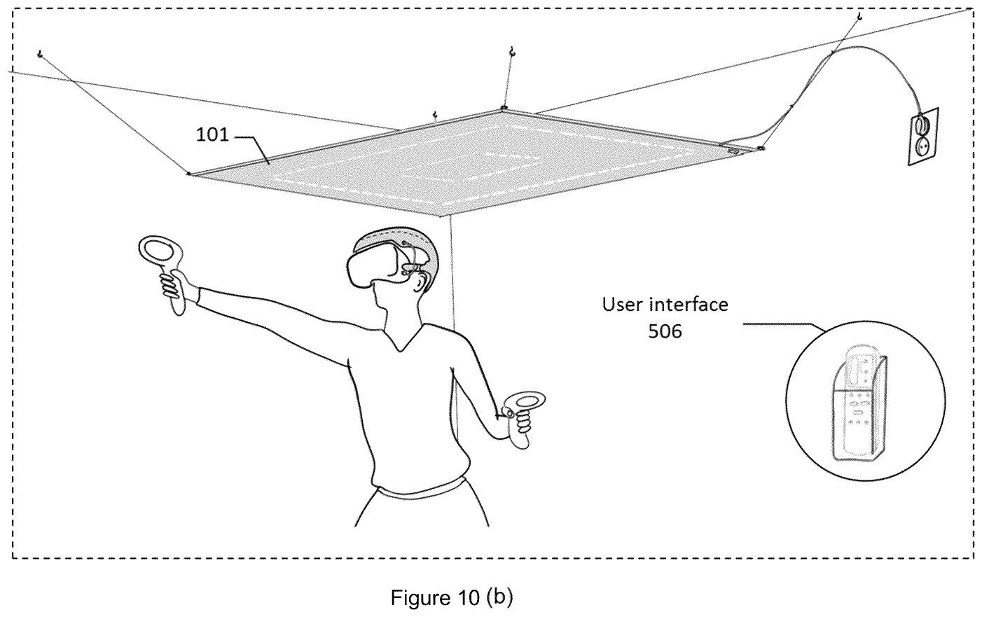

FIG. 10 shows two possible implementations of the disclosed transmitter device. The implementation in FIG. 10a depicts the wireless power transmitter device 101 containing all modules, 102 and 103 inside a rigid shell with the mechanical stability for the panel to be hung from the ceiling as well as a light status and ON/OFF button as a user interface comprised within the same device. While FIG. 10b shows a wireless power transmitter system 101 with separate user interface, a remote control, this implementation has the advantage of being remotely operated without having to reach to the transmitter's height.

FIG. 11 demonstrates possible implementations of the shielded magnetic components on the transmitter and the receiver side. FIG. 11b depicts the magnetics module 106 in the receiver device 105 in detail, the module comprises an outer insulation material 1101, a shield material or a combination of materials 106.b, for example an assembly of a conductive material on the top and a magnetic shielding material on the bottom, thus shielding most of the received electromagnetic field by the receiver coil 106.a from the head of the user. In some implementations the transmitter and receiver coil can be mounted on a carrier substrate 1103 and 1104. Similarly, FIG. 11a demonstrates that by the use of a shielding material or a combination of materials 508.b the ceiling is mostly shielded from the electromagnetic field generated by the transmitter coil 508.a and vice versa. Furthermore, 1102 show an outer insulation material used to enclose the magnetics module on the transmitter device.

FIG. 12 depicts some possible implementations of the inductive element of the transmitter device 101. FIG. 12a shows in FIG. 12a.1 the possibility of having an array of coils inside the magnetics module 103 on the transmitter 101, for example, the central coil 1201 can be connected to the power supply 102 and the outer coils 1202, enclosing 1201, can be a certain number of relay resonators effectively extending the transmission range of the excited coil 1201. This implementation has the advantage of requiring a single power source 102. FIG. 12a.2 shows on the other hand, an implementation with a single transmitter coil connect to the power supply 102 covering a larger area, comparable to the area covered by the excited coil and relay resonators in FIG. 12a.1.

FIG. 12b exemplifies that depending on the geometry of the inductive element of the resonator inside the transmitter device 101, a different magnetic field characteristic can be expected. For example, FIG. 12b.1 shows a substantially flat 3-dimensional transmitter coil having a main plane and a certain number of turns. This image shows a square coil but the coil geometry can be different. Due to the geometry of the coil, each turn has four vertices. The principal characteristic of this coil is that at least the four vertices composing a single turn are displaced with a certain negative height relative to the main coil plain. This image shows how all the vertices of each turn are displaced. Displacing the vertices of the turns of this coil has left some of the sections of the turns at the same height as the main plane. Displacing the vertices of the coil decrease the mutual inductance in critical zones when the receiver is located directly on top of the transmitter device's shell. Decreasing these maximum peaks of mutual inductance reduce the variations of the induced voltage in the receiver, as well as the maximum component stresses in the receiver avoiding possible damage of the receiver while allowing the transmitter to work with a constant current level, a necessary feature in one-to-one or one-to-many wireless power transfer systems. The resulting magnetic field characteristic of the transmitter coil FIG. 12b.1 can be observed in FIG. 12b.2.

FIG. 12b.3 shows a possible implementation of a transmitter coil inside the magnetics module 103 having a differing winding characteristic in such a way that the spacing between the turns of the coil varies. Such an implementation allows to create a more uniform characteristic of the magnetic field, as depicted in FIG. 12b.4.

FIG. 12b.4 shows a coil with two winding sections 1203 and 1204 of the transmitter coil inside the magnetics module 103. The sections are joined by a segment 1205 in such a way that the current through the sections has a given current direction. In the case of the coil in FIG. 12b.5, the current through both sections is flowing in the same direction. In other implementations, the current can flow in a different direction. Having two winding sections allow to create two sections of the magnetic field, as depicted in the characteristic in the magnetic field depicted in FIG. 12b.6. This implementation has the advantage of creating two charging hotspots, under which, not one but two users can be standing.

FIG. 13 and FIG. 14 show several possible implementations of receiver devices located on the head of the user. By placing the receiver device 105 on the area on top of the head, a good electromagnetic coupling to the transmitter device can be ensured, as well as a continuous power delivery to the end-device 109. FIG. 13 shows how by means of an attachment mechanism, the power receiver device can be an accessory attached to the already existing head mounted device 109.

FIGS. 14a and 14b show yet another possible implementation of the receiver device 105. Such a device is also an accessory but, in this case, designed to be fitted within a headset. The receiver device is meant to replace the tightening mechanism of the already existing head mounted end-device 109. This implementation also shares the advantage of letting the user use the receiver device with his already available headset but as a more comfortable single item.

As depicted by FIG. 14c, the wireless power receiver device can also be embedded inside the user's end-device 109. Although this implementation requires the user to have an end-device fitted with a receiver device, it presents the advantage of increased comfort and ease of use.

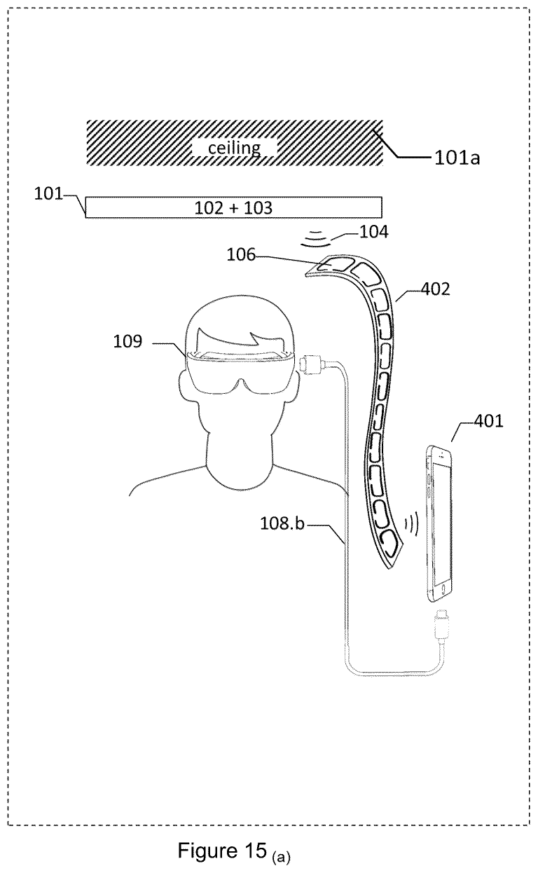

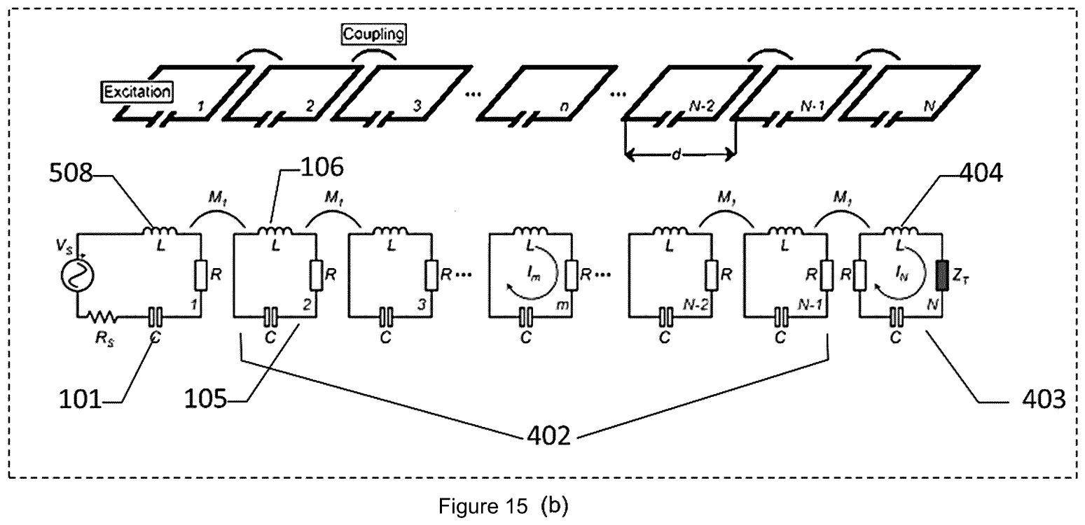

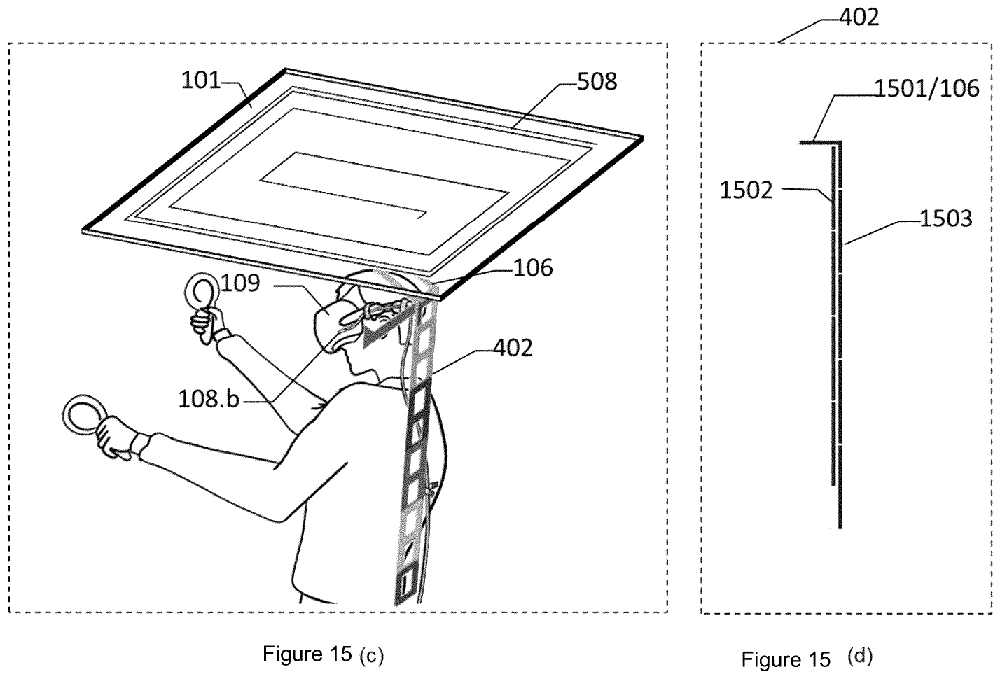

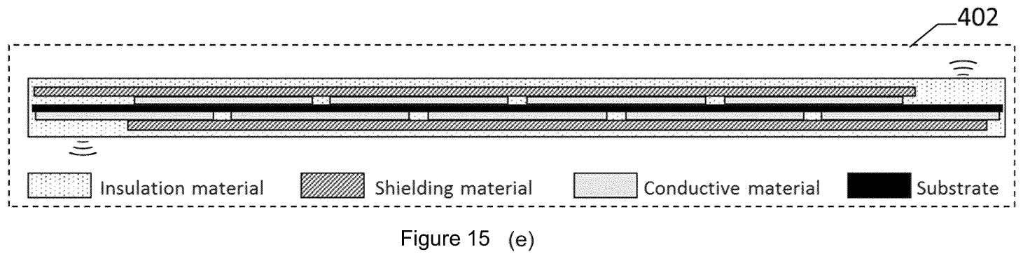

FIG. 15 shows a possible implementation of a wireless power transfer system that uses an electromagnetic power distribution medium 402 to deliver wireless power to the intermediate electronic device 401 that has a compatible wireless power receiver 403. FIG. 15a depicts how the wireless power generated by the transmitter device 101 is guided through an array of coupled resonators 402 capable of guiding the electromagnetic field 104 generated by the transmitter 101 to further increase the transmission range of the transmitter device 101 to the intermediate device 401. In this case, the intermediate device 401 is already fitted with a wireless power receiver device capable of converting the received electromagnetic field into electrical energy suitable to charge the battery on the intermediate device 401 as well as to deliver electrical power to the end electronic device 109 through the power delivery medium 108.b with purpose of charging its battery by performing an electrical connection.

FIG. 15b depicts a circuit diagram and the working principle of the power distribution medium 402. 402 is a medium capable of guiding the electromagnetic field generated by the transmitter. The medium can be composed by a given number of cells, the picture shows N cells for generality. Each of the cells of this electrical diagram is an inductive-capacitive resonator that is electromagnetically coupled to at least each nearest neighbor. This coupling is represented by the mutual inductance M1, which in this figure is considered to be mostly magnetic, due to the magnetic field generated by one cell that threads the neighboring cell and therefore induces a circulating current in this cell. Each cell is represented by a series connection of an inductance L with its associated resistance R and connected in series with an external capacitance C. The figure denotes that the capacitance is implemented by an added lump element but in some other implementations, the self-capacitance of the coil can also be used. Each one of the cells of the diagram is forming a series resonator circuit with a given resonant frequency.

The first cell in the circuit diagram of FIG. 15b is the resonator circuit inside the transmitter device 101. Note that due to the electromagnetic coupling that exists between the transmitter device 101 and its nearest neighbor, i.e., the first cell of the coupled resonator array 402, which in this case is the wireless power receiver 105, the power can be guided from the transmitter all the way to the device 401. The las cell of the circuit diagram of FIG. 15b is the resonator circuit inside the receiver device 401, i.e., the wireless power receiver 403. The load resistance Z_{T} in this circuit diagram represents the battery of the wearable electronic device 401 and/or 109. The amount of energy being lost along the way will depend on the quality factor of the cells as well as the mutual inductance between them.

FIG. 15c shows how the power distribution medium is thought to interact with the transmitter 101 and the user. The power distribution medium can be implemented on a semi-rigid or a flexible substrate. In fact, a flexible substrate would have the advantage of being compliable and therefore being easier to be attached to the user wearing it. Note that in this figure a transmitter coil 106 able to produce a quite homogeneous field, like demonstrated in FIG. 12b.3 and FIG. 12b.4 has been employed but any other coil geometry like the ones presented in FIG. 12 can also be used.

The second cell of FIG. 15b, also shown in FIG. 15d, is located on top of the user's head and it has a bending angle of approximately 90 degrees 1501, i.e., approximately 50% of the cell's surface is located on top of the head and the remaining surface is located substantially parallel to the user's back. The consecutive cell, i.e., cell number three in FIG. 15b or 1502 in FIG. 15d has approximately 50% of overlapping with 1501 and its consecutive cell 1503. The same can be said for the remaining cells shown in FIG. 15d, thus the cells are forming something that resembles a brick-wall configuration. This configuration has the advantage of having a good mutual inductance between neighboring cells. Note that in FIG. 15b, all cells pairs have the same mutual inductance but this value can be different. Also, there can be a second order mutual inductance, i.e., between non-consecutive cells, or a third-order mutual inductance.

FIG. 15e shows a possible and detailed implementation of the wireless power distribution medium 402. From top to bottom, the medium can be enclosed by an electrically insulating material, the upper layers of cells can be on the upper layer a printed circuit board and it can be separated by a flexible substrate from the lower layer of cells. The cells' arrangement is mostly shielded by a shielding material or a combination of materials such as a stack of an electrically conductive material and a magnetically conductive material. Unshielded areas at the end and the beginning of the medium are useful in order for it to be coupled to the transmitter and the intermediate receiver. Note that under the bottom cells, a similar shielding arrangement can be implemented. Possible variations of this arrangement can include more carrier substrates, for example at the top of the top cells and at the bottom of the bottom cells. This can be implemented by two individual printed circuit boards sandwiched together with a suitable electrically insulating interface between them. In some other implementations the magnetic shield can be removed as the energy from one cell to the next is capable of being transferred due to their mutual inductance, same that can be increased by employing the magnetic material.

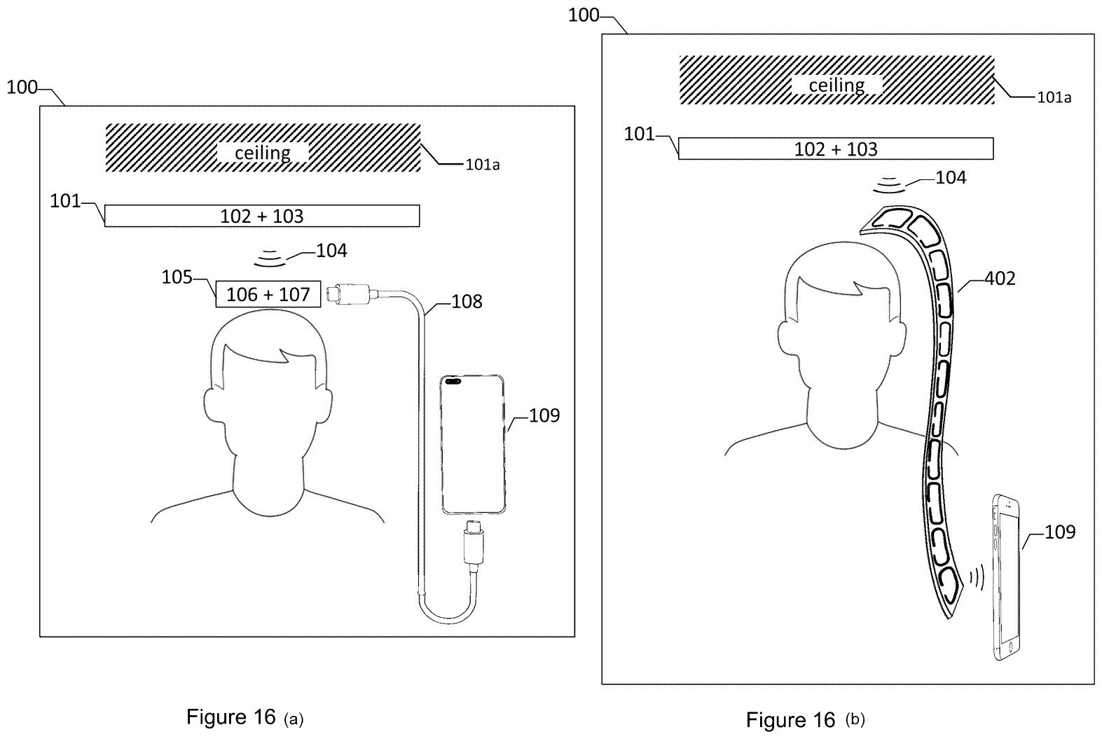

The devices disclosed in the embodiments of the present disclosure can also be used to provide wireless power to the intermediate devices as exemplified in FIG. 16. The situation exposed by FIGS. 16a and 16b can arise if the user decides to momentary remove the head-mounted device but still provide wireless power to the intermediate device. In such a case the intermediate device 401 of FIG. 6 will become the end-device 109 in FIG. 16a. Similarly, the device, 401 of FIG. 7 will become the end-device 109 in FIG. 16b. In these situations, the disclosed technology can also be employed without the need of having a head-mounted device, i.e., with the purpose of providing wireless power to the intermediate devices.

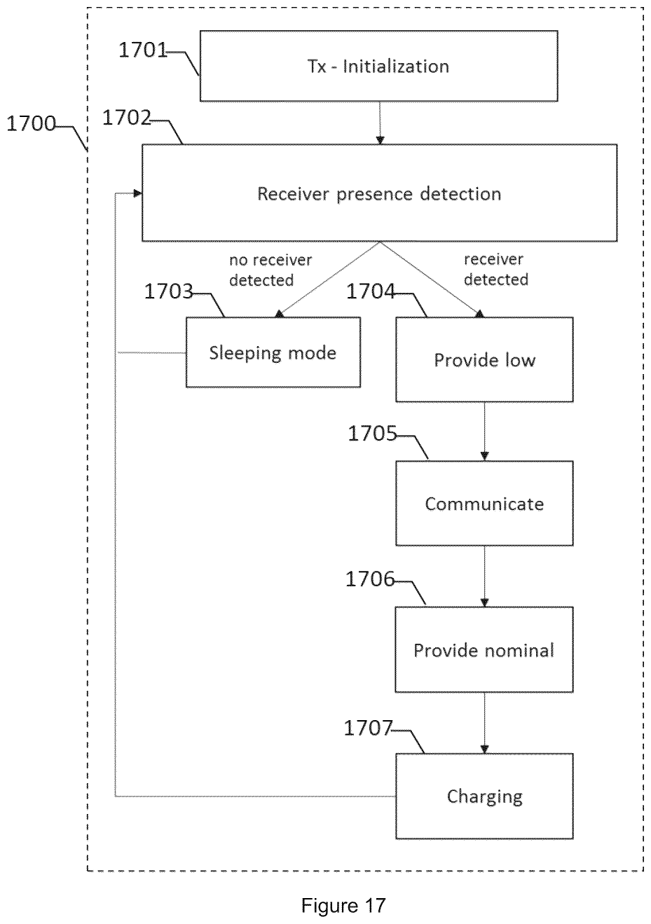

The disclosure also discloses a method 1700 to charge the battery of an extended reality headset under the dynamic movement of the user. The method 1700 is depicted in FIG. 17 and can be summarized as:
Initialization 1701: user action enables (turns ON) mat-like WPT transmitter device
Receiver presence detection 1702: detect presence of one or more compatible head-mounted wireless power receiver devices within the charging region
   If no receiver is detected:
Sleeping mode 1703: Tx goes into sleeping mode and keep looping until it detects an Rx
   If Rx is detected:
Provide low power 1704: Tx provides and Rx receives wireless power at low power to be able to start communication and pairing protocol.
Communicate 1705: communication between Tx and Rx is stablished to determine compatibility. User interfaces 506 and 514 are operated to display pairing mode is in place
Provide nominal power 1706: Tx provides and Rx receives wireless power at nominal power levels
Charging 1707: Rx enables power output to supply/charge device 109. User interfaces 506 and 514 are operated to display charging mode is in place.

The method 1700 depicted in FIG. 17 can be used for powering a wearable electronic device 109 as described in this disclosure. In other words, the method 1700 comprises: enabling 1701 a ceiling-mountable power transmitter 101 according to the disclosure; detecting 1702, by the ceiling-mountable power transmitter 101, one or more wearable wireless power receivers 105 according to the disclosure; upon detecting a wearable wireless power receiver 105 according to the disclosure, providing 1704, by the ceiling-mountable power transmitter 101, an initial power to the wearable wireless power receiver 105 for communicating 1705 a pairing mode between the ceiling-mountable power transmitter 101 and the wearable wireless power receiver 105; and providing 1706, by the ceiling-mountable power transmitter 101, a nominal power to the wearable wireless power receiver 105 for powering 1707 at least one of a wearable electronic device 109 and a second wearable electronic device 401.

The solutions presented in this disclosure are applicable to wireless power receiver devices like smartphones, wearables like smartwatches, fitness bands, virtual reality headsets and hand-controllers, over-ear headphones, tablets, portable computers, smart glasses, gaming controllers, desktop accessories like a mouse or keyboard, battery banks, remote controls, hand-held terminals, e-mobility devices, portable gaming consoles, portable music players, key fobs, drones used in wireless power transfer systems that allow a high-degree of freedom of the receiver.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although aspects have been illustrated and described herein, it will be appreciated by those of ordinary skill in the art that a variety of alternate and/or equivalent implementations may be substituted for the aspects shown and described without departing from the scope of the disclosure. This application is intended to cover any adaptations or variations of the aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the disclosure beyond those described herein. While the disclosure has been described with reference to one or more particular embodiments, those skilled in the art recognize that many changes may be made thereto without departing from the scope of the disclosure. It is therefore to be understood that within the scope of the appended claims and their equivalents, the disclosure may be practiced otherwise than as described herein.

What is claimed is:

1. A wearable wireless power receiver for receiving an electromagnetic field and transforming the electromagnetic field into electric power for powering a wearable electronic device, the wearable wireless power receiver being configured to locate at the head of a person, wherein the wearable wireless power receiver comprises:
a carrier substrate;
an electrically conductive material mounted at the carrier substrate, wherein the electrically conductive material forms at least one receiver coil,
wherein the carrier substrate with the mounted electrically conductive material is formed to adapt to a head area of the person,
wherein the at least one receiver coil is configured to receive an electromagnetic field.

2. The wearable wireless power receiver of claim 1, comprising:
a shielding material mounted at the carrier substrate, the shielding material being configured to shield the head of the person from at least a portion of the electromagnetic field.

3. The wearable wireless power receiver of claim 2,
wherein the carrier substrate with the mounted electrically conductive material and with or without the shielding material is formed to be removably attached at an upper part of a headwear or a headset device to be worn by the person.

4. The wearable wireless power receiver of claim 2,
wherein the carrier substrate with the mounted electrically conductive material and with or without the shielding material is formed to be embedded into a headwear to be worn by the person.

5. The wearable wireless power receiver of claim 2,
wherein the carrier substrate with the mounted electrically conductive material and with or without the shielding material is formed to be embedded into the wearable electronic device.

6. A wearable coupled resonator array comprising,
a wearable wireless power receiver of claim 1;
wherein the wearable coupled resonator array is configured to extend from the head area of the person to a location of the wearable electronic device or to a location of a second wearable electronic device,
wherein the wearable coupled resonator array is configured to receive an electromagnetic field and to relay it from the head area of the person to the location of the wearable electronic device or to the location of the second wearable electronic device.

7. A wearable wireless power receiver arrangement for powering at least one of a wearable electronic device or a second wearable electronic device, the wearable wireless power receiver arrangement comprising:
a wearable wireless power receiver according to claim 1;
a wearable electronic device and/or a second wearable electronic device configured to be powered by the wearable wireless power receiver; and
an electric guide configured to transport the electric power from at least one of the wearable wireless power receiver and the second wearable electronic device to at least one of the wearable electronic device and the second wearable electronic device.

8. The wearable wireless power receiver arrangement of claim 7,
wherein the second wearable electronic device is configured to charge itself with part of the electric power and forward the rest of the electric power received via a first electric guide from the wearable wireless power receiver via a second electric guide to the wearable electronic device.

9. The wearable wireless power receiver arrangement of claim 7,
wherein the second wearable electronic device comprises a wireless power receiver entity that is configured to:
receive the electromagnetic field from a coupled resonator array,
convert the electromagnetic field into electric power,
charge itself with part of the electric power, and/or
forward the remaining part of the electric power via an electric guide to the wearable electronic device.

10. A ceiling-mountable power transmitter for powering at least one of a wearable electronic device and a second wearable electronic device through the use of a wearable wireless power receiver arrangement according to claim 7, the ceiling-mountable power transmitter comprising:
a power source;
a carrier substrate;
an electrically conductive material mounted at the carrier substrate, the electrically conductive material forming at least one transmitter coil,
wherein the carrier substrate with the mounted electrically conductive material is formed to adapt to a ceiling,
wherein the at least one transmitter coil is configured to transmit an electromagnetic field for powering at least one of a wearable electronic device and a second wearable electronic device.

11. The ceiling-mountable power transmitter of claim 10, comprising:
a shielding material mounted at the carrier substrate, the shielding material being configured to shield the ceiling from the power transmitter and vice versa.

12. The ceiling-mountable power transmitter of claim 10, comprising:
substrate extensions located at corners of the carrier substrate, the substrate extensions being displaced in height with respect to a main plane of the carrier substrate,
wherein the at least one transmitter coil is formed on the carrier substrate and on the substrate extensions.

13. The ceiling-mountable power transmitter of claim 10,
wherein the at least one transmitter coil is configured to generate at least two charging hotspots for powering at least a wearable electronic device and a second wearable electronic device.

14. The ceiling-mountable power transmitter of claim 10,
wherein the carrier substrate with the mounted electrically conductive material and with or without the shielding material mounted at the carrier substrate, the shielding material being configured to shield the ceiling from the power transmitter and vice versa is formed to be embedded in a panel attachable to the ceiling or to be embedded into the ceiling.
